(19) United States
(12) Patent Application Publication
(10) Pub. No.: US 2026/0048624 A1
(43) Pub. Date: Feb. 19, 2026

(54) TRAILER COUPLING

(71) Applicant: ACPS Automotive GmbH, Ingersheim (DE)

(72) Inventor: Wolfgang Gentner, Steinheim (DE)

(73) Assignee: ACPS Automotive GmbH, Ingersheim (DE)

(21) Appl. No.: 19/289,649

(22) Filed: Aug. 4, 2025

(30) Foreign Application Priority Data
Aug. 15, 2024 (DE) 102024123337.0

(51) Int. Cl. B60D 1/06; B60D 1/54

(52) U.S. Cl. CPC B60D 1/06; B60D 1/54; B60D 2001/544

(57) ABSTRACT

In the case of a trailer coupling comprising a ball neck which can be moved between a working position and a rest position and which is connected at a first end to a pivot bearing unit and carries a coupling ball at a second end, the ball neck being pivotable about a pivot axis between the working position and the rest position by means of the pivot bearing unit when a pivoting movement is carried out, and a rotation blocking device acting between a guide body and a pivot bearing body of the pivot bearing unit, having on the one hand at least two rotation blocking units, in order to create the simplest structural and safest solution possible, it is proposed to provide a multiple blocking device, which comprises a blocking body which can be moved into a rest position blocking position blocking the pivot bearing body and the guide body relative to each other in the rest position, into a securing position securing the actuating body in the rotation blocking position, and into an intermediate position lying between the rest position blocking position and the securing position.

### CROSS-REFERENCE TO RELATED PATENT APPLICATION

The present disclosure relates to the subject matter disclosed in German application number 10 2024 123 337 of 15 Aug. 2024, which is incorporated herein by reference in its entirety and for all purposes.

### BACKGROUND OF THE INVENTION

The invention relates to a trailer coupling, comprising a ball neck which can be moved between a working position and a rest position, is connected at a first end to a pivot bearing unit and carries a coupling ball at a second end, the ball neck being pivotable about a pivot axis between the working position and the rest position by means of the pivot bearing unit when a pivoting movement is carried out, and a rotation blocking device acting between a guide body and a pivot bearing body of the pivot bearing unit, having on the one hand at least two rotation blocking units, each of which has a rotation blocking body which is guided movably in a guide direction by means of a guide receptacle of the guide body and which is movable in the guide direction by a pushing surface extending transversely to the guide direction and provided on an actuating body, and having on the other hand at least two receptacles, wherein the rotation blocking bodies of all rotation blocking units are configured to be moved and acted upon in the guide direction by a movement of the actuating body in an actuating direction and wherein the rotation blocking bodies of all rotation blocking units are configured to be brought into a rotation blocking position in the working position by a movement in the guide direction and in this position come into engagement by means of one of the receptacles in each case in order to block a pivoting movement of the pivot bearing body and of the guide body relative to one another about the pivot axis, and are configured to be brought into a release position, and in this position are disengaged from the respective receptacle and release the relative movement between the pivot bearing body and the guide body, wherein in all intended relative pivot positions between the pivot bearing body and the guide body, including the rest position and excluding the working position, a movement of the actuating body in the actuating direction and consequently also a force-loaded engagement of the rotation blocking bodies of each of the rotation blocking units in one of the receptacles in each case is blocked.

A trailer coupling of this kind is known from the prior art, for example DE 10 2020 111 469.

In accordance with an embodiment of the invention, the simplest structural solution possible is created.

### SUMMARY OF THE INVENTION

In accordance with an embodiment of the invention, provision is made in the case of a trailer coupling of the kind described at the outset that a multiple blocking device is provided, which comprises a blocking body which is moveable into a rest position blocking position blocking the pivot bearing body and the guide body relative to each other in the rest position, into a securing position securing the actuating body in the rotation blocking position, and into an intermediate position lying between the rest position blocking position and the securing position.

The advantage of the solution according to the invention is thus to be seen in the fact that it permits easy blocking of the pivot bearing unit in the rest position and also securing of the rotation blocking position of the pivot bearing unit in a securing position.

It is particularly advantageous if the blocking body is guided on the guide body of the pivot bearing unit.

One option for guiding the blocking body on the guide body is for the blocking body to be guided in a guide arranged on the guide body.

In particular, it is provided, for this purpose, for the guide for the blocking body to be arranged in a wall region of the guide body adjacent to the actuating body.

It is particularly advantageous if this wall region is located between the actuating body and the pivot bearing body, in particular a flange thereof, so that the blocking body can interact with both the actuating body and the pivot bearing body in order to realize both the securing position and the rest position blocking position.

In principle, it would be conceivable to move the blocking body radially to the pivot axis.

However, in terms of the simplicity of the structural solution, it is particularly advantageous if the blocking body can be moved in the guide in a direction approximately parallel to the pivot axis.

Furthermore, an advantageous solution provides for the blocking body to engage in a receptacle in the pivot bearing body in the rest position.

In addition, it is advantageous if the blocking body engages in a receptacle in the actuating body in the securing position

In order to be able to easily position the blocking body in the intermediate position, it is preferable for the blocking body to be arranged in the intermediate position between the receptacle in the actuating body and the receptacle in the pivot bearing unit.

In order to be able to fix both the securing position and the rest position blocking position in a simple manner, it is preferably provided that the blocking body engages with one end in the respective receptacle both in the securing position and in the rest position blocking position, starting from and guided by the guide.

In conjunction with the previous explanation of the individual solutions, it was not discussed in more detail how the blocking body should be actuated and how it should be fixed in the securing position, the intermediate position and the rest position blocking position.

This can be advantageously realized in that the blocking body is fixable in the securing position, the intermediate position and the rest position securing position by a blocking actuating device.

The blocking actuating device could be formed in a wide variety of ways.

An advantageous solution thus provides for the blocking actuating device to comprise a camming guide and a cam follower which is moveable by this and which is coupled to the blocking body.

Furthermore, it is preferably provided that the cam follower is moveable by the camming guide approximately parallel to the pivot axis in order to thereby actuate the blocking body in a simple manner.

It is also provided that the camming guide is moveable transversely to the pivot axis.

Preferably, it is provided that the camming guide is moveable by the blocking actuating device.

For example, it is provided for this purpose that the blocking actuating device comprises a body that carries the camming guide and is moveable in rotation relative to the cam follower.

Furthermore, the camming guide is preferably configured such that it has at least one camming path acting on the cam follower.

It is even more advantageous if the camming guide has two camming paths acting on the cam follower and guiding it between them.

It is expediently provided that both camming paths together to fix the cam follower in a position that defines the securing position.

Furthermore, it is preferably provided that both camming paths together to fix the cam follower in a position that defines the rest position blocking position.

The above functions can preferably be realized in that a first camming path has a path portion that is configured to move the cam follower from the position defining the securing position into a position defining the intermediate position.

Furthermore, it is preferably provided that the first camming path comprises a path portion that moves the cam follower from the position defining the intermediate position in the direction of and into a position corresponding to the rest position blocking position.

In particular, it has proven to be advantageous if the path portion acting in the direction of the position corresponding to the rest position blocking position acts on the cam follower elastically in this direction.

In particular, it is provided here that the path portion acting in the direction of the position corresponding to the rest position blocking position is formed by a portion of the first camming path that can be moved elastically.

Such a configuration of the first camming path has the advantage that the cam follower can be acted upon elastically and therefore does not necessarily have to enter the rest position blocking position when acted upon in the direction of the position corresponding to the rest position blocking position, but can only enter the rest position blocking position when the receptacle in the pivot bearing body is aligned with the blocking body in the intermediate position.

When the blocking body is in the rest position blocking position, it is fixed in the rest position blocking position by the cam follower being fixed between the resiliently movable portion of the first camming path in cooperation with the second camming path, wherein the resiliently movable portion of the first camming path has moved towards the second camming path by reaching the rest position blocking position by the blocking body, so as to thus fix the rest position blocking position between the resiliently movable portion of the first camming path and the second camming path.

In order to release the rest position blocking position again, it is provided that the second camming path has a path portion which moves the cam follower from the position corresponding to the rest position blocking position to a position corresponding to the intermediate position.

In order to also be able to reach the securing position again from the intermediate position, it is provided that the second camming path has a path portion which moves the cam follower from the position corresponding to the intermediate position to the position corresponding to the securing position.

In particular, in these exemplary embodiments, it is provided that the first camming path is effective by a movement of the camming guide in a first rotational direction and that the second camming path is effective by a movement
of the camming guide in a rotational direction opposite to the first rotational direction.

With regard to the actuation of the blocking actuating device for moving the blocking body, no further details have yet been provided.

In principle, it would be conceivable to couple the blocking actuation device with a controllable drive unit.

However, it is particularly advantageous if the blocking actuating device is driveable by an actuating device for the rotation blocking device, as this makes it easier to coordinate the movements of the blocking body to be triggered by the blocking actuating device with the actuation of the rotation blocking device.

In particular, it is provided that the blocking actuating device is coupled with the actuating device for the rotation blocking device.

This coupling can be achieved preferably in that the camming path is arranged on a rotatable body of a planetary gearing of the actuating unit for the rotation blocking device.

In particular, it is preferably provided that the camming path is arranged on a ring gear of a planetary gearing of the actuating unit.

In order to be able to optimally monitor the multiple blocking device, it is preferably provided that the multiple blocking device has a sensor unit that detects the positions of the blocking body.

The sensor unit is preferably configured in such a way that it detects the securing position, the rest position blocking position and the intermediate position.

In particular, the sensor unit comprises, for example, one or more push-buttons as sensors that detect sensing surfaces.

In the case of a sensor configured as a push-button, the sensor unit is able to distinguish the intermediate position from the securing position or the rest position of the blocking body by detecting the positions of the sensor actuating element, for example.

In the case of several push-buttons, for example two push-buttons, the sensor unit is able to distinguish each of the positions of the blocking body, such as the securing position, intermediate position and rest position blocking position, from the other position by means of an evaluation unit by detecting the positions of the sensor actuating element.

A further advantageous solution provides that the sensor unit is configured as a magnetic field sensor, which detects different magnetic fields depending on whether the securing position, the rest position blocking position or the intermediate position is present, and can therefore distinguish between all of these.

In the case of a sensor that detects magnetic field directions in space, the sensor unit is also able to distinguish each of the positions of the blocking body, such as the securing position, intermediate position and rest position blocking position, from the other position by means of an evaluation unit by detecting a course of the magnetic field of the sensor actuating element.

In particular, for coupling the cam follower to the blocking body, said follower is coupled to the blocking body by means of a transmission element.

In this case, the transmission element can be easily coupled with a sensor actuating element so that the sensor unit is able to detect the positions of the transmission element.

The sensor actuating element can have different scannable elements that the sensor unit detects or, in the case of a sensor unit with a magnetic field sensor, detects magnetic fields aligned differently relative to the sensor unit in space depending on its position.

With regard to the blocking of the actuating body in the actuating direction in all relative pivot positions between the pivot bearing body and the guide body, including the rest position, no further details have yet been provided.

An advantageous embodiment of the invention thus provides that blocking surfaces extend between the receptacles, against which blocking surfaces the rotation blocking bodies are placeable and from which the receptacles extend, that the rotation blocking units and the receptacles are arranged around the pivot axis at angular spacings from one another in such a way that, in all provided relative pivot positions between pivot bearing body and guide body including the rest position and apart from the working position, the rotation blocking body of at least one of the rotation blocking units is opposite one of the blocking surfaces and thus this blocking surface, in particular when a force is applied to the actuating body in the direction of the actuating direction, blocks a movement of the actuating body in the actuating direction and consequently also a force-loaded engagement of the rotation blocking bodies of each of the rotation blocking units in one of the receptacles.

The advantage of the solution according to the invention is thus to be seen in the fact that the fixing of the actuating body in the release position can be realized in a simple and reliable manner by means of the already existing rotation blocking bodies and that, in addition, a significant noise reduction occurs during the transition of this trailer coupling from the release position to the rotation blocking position of the rotation blocking bodies, since the rotation blocking bodies can slide easily from the blocking surfaces into the receptacles.

Alternatively or additionally, it is furthermore provided in the case of a trailer coupling of the type described at the outset that the rotation blocking units are arranged at angular spacings around the pivot axis to form a rotation blocking configuration, in that the receptacles for forming a receptacle configuration are arranged at the same angular spacings around the pivot axis as the rotation blocking units, in that the rotation blocking configuration and the receptacle configuration in the working position are congruent with one another, so that the rotation blocking bodies can engage in the receptacles, and in that the angular spacings between the rotation blocking units of the rotation blocking configuration and the angular spacings between the receptacles of the receptacle configuration are selected such that the rotation blocking configuration and the receiving configuration are only congruent with one another in the working position and thus only in these allow a transition of the actuating body from the release position to the rotation blocking position, while in the other pivot positions of the pivot bearing body a transition of the actuating body from the release position to the rotation blocking position is not possible.

Alternatively or in addition to the solutions described above, a further advantageous solution provides that the angular spacings of at least one of the rotation blocking units to the rotation blocking units arranged adjacent in a direction of revolution about the pivot axis and to the rotation blocking units arranged adjacent in the opposite direction to this rotational direction are unequal, and that in the working position the receptacles are arranged in such a way that the rotation blocking bodies of each of the rotation blocking units are configured to be brought into engagement with one of the receptacles, and that in all relative pivot positions between pivot bearing body and guide body, which are provided for operation and which lie outside the working position, the rotation blocking body of at least one of the rotation blocking units lies opposite a blocking surface located between the receptacles and this blocking surface thus blocks a movement of the actuating body from the release position into the rotation blocking position, in particular when force is applied to the actuating body.

Starting from equal angular spacings, the inequality of the angular spacings amounts, for example, to at least one deviation from equal angular spacings in the order of magnitude of half the angular range over which each of the receptacles extends, preferably up to the angular range over which each of the receptacles extends.

The advantage of all the above-mentioned solutions according to the invention is that they provide a structurally simple solution for holding the actuating body in the release position and only allowing it to move into the rotation blocking position in the working position, wherein in particular the rotation blocking bodies already available for the rotation blocking device can advantageously be used.

In conjunction with the solution according to the invention, it has proven to be particularly expedient if the number of rotation blocking units corresponds to the number of receptacles.

Furthermore, in particular in order to obtain a spatially compact solution, in particular in the direction of the pivot axis, it is advantageous if the rotation blocking bodies of all rotation blocking units are configured and arranged symmetrically to a geometric plane running perpendicular to the pivot axis and intersecting it.

A particularly advantageous solution is for the blocking surfaces to face the rotation blocking bodies of the rotation blocking units, in particular transversely, preferably perpendicular to the guide direction, so that the rotation blocking bodies are configured to be moved over the blocking surfaces with little or virtually no resistance to movement when they come into contact with them.

It is particularly advantageous if the blocking surfaces run in a defined radius around the pivot axis, so that during the pivoting movement the rotation blocking bodies resting on these blocking surfaces do not perform any additional radial movement relative to the pivot axis.

Furthermore, it is advantageously provided that the blocking surfaces extend up to the opening edges of the receptacles and merge into these.

In particular, it is preferably provided that the opening edges of the receptacles are at the same radial spacing from the pivot axis as the blocking surfaces, so that the rotation blocking bodies in contact with the blocking surfaces can be moved beyond the opening edges into the receptacles without additional resistance to movement, as would occur, for example, if the opening edges were at different spacings from the pivot axis in relation to the spacing of the blocking surfaces from the pivot axis.

In particular, this solution also has the advantage that it enables a simple transition from the working position to a pivot position without resistance to movement, since in this case the rotation blocking bodies can also leave the receptacles substantially without resistance to movement by means of the opening edges and can move in the direction of the blocking surfaces.

It is particularly advantageous if at least one of the rotation blocking bodies of the rotation blocking units abuts against one of the blocking surfaces during a pivoting movement in the direction of the working position, in particular during the pivoting movement from the rest position to the working position, in particular by way of an application of force by the actuating body, wherein the application of force is effected, for example, by retraction receptacles provided in the actuating body for the release position of the rotation blocking bodies, which retraction receptacles act on the rotation blocking bodies with surfaces running transversely to the guide direction.

In particular, it is advantageous if the rotation blocking bodies abut in a force-loaded manner against the blocking surfaces before reaching the working position and then enter the receptacles abutting in a force-loaded manner against the opening edges of the receptacles, so that the noise level can be kept as low as possible when the rotation blocking bodies move from the release position to the rotation blocking position, in contrast to a case in which the rotation blocking bodies are initially arranged relative to the blocking surfaces with play, are then applied with force to the blocking surfaces and then enter the receptacles from the blocking surfaces or the case in which the rotation blocking bodies move into the working position lying with play to the blocking surfaces and experience the application of force in the working position in order to enter the receptacles.

With regard to the configuration of the receptacles, it is particularly advantageous if the receptacles extend from the blocking surfaces in the guide direction, in particular with at least one component in the radial direction to the pivot axis, so that the rotation blocking bodies do not experience any additional deflection when moving in the guide direction when entering the receptacles.

Furthermore, no further details have been provided with regard to the alignment of the receptacles and the blocking surfaces relative to the guide sleeve.

An advantageous solution is that the receptacles and the blocking surfaces are arranged facing the guide sleeve, so that a deflection-free movement of the rotation blocking body in the direction of the blocking surfaces or in the direction of the receptacles can take place.

In principle, the guide body or the pivot bearing body could be pivotable about the pivot axis.

However, a particularly favorable structural solution is that the guide body of the part of the pivot bearing unit is fixed to the vehicle.

Furthermore, with regard to the configuration of the guide body, it is envisaged that all guide receptacles for the rotation blocking bodies of the rotation blocking units are arranged in the guide body.

Furthermore, it is expedient if the guide direction runs with at least one component in the radial direction to the pivot axis, so that the rotation blocking bodies are moved at least with one component in the radial direction to the pivot axis between the rotation blocking position and the release position and thus no exclusive movement of the rotation blocking bodies in the direction of the pivot axis takes place in order to move them between the rotation blocking position and the release position.

A particularly favorable structural solution is that the guide body has a guide sleeve with guide receptacles for the rotation blocking bodies of the rotation blocking units and that, in particular, the rotation blocking bodies are guided by the guide body which adjoins the pivot bearing body in the radial direction.

In conjunction with the explanation of the above exemplary embodiments, no further details were given as to how the pivot bearing body of the pivot bearing unit should be pivotably mounted relative to the guide body.

For example, a bearing provided for this purpose could be provided on the pivot bearing unit, which bearing is independent of the guide body.

However, it is particularly simple in terms of structure if a pivot bearing is provided between the guide body and the pivot bearing body.

No further details have been provided with regard to the movement of the actuating body in relation to the guide body.

Thus, an advantageous solution provides for the actuating body to be movably guided relative to the guide body.

In this case, the actuating body could be movable relative to the guide body in the direction of the pivot axis between the rotation blocking position and the release position in order to move the rotation locking bodies in the corresponding positions.

A solution that is optimized in terms of the spatial requirement provides for the actuating body to be arranged rotatably about the pivot axis and, in particular, to have wedge surfaces extending over an angular range about the pivot axis and varying in the direction parallel to the guide direction, preferably combined with retraction receptacles.

In addition, no further details were provided with regard to the arrangement of the receptacles and the blocking surfaces.

Thus, an advantageous solution provides that the receptacles and the blocking surfaces are arranged on the pivot bearing body.

Furthermore, a structural solution is particularly favorable in terms of absorbing the acting forces if the actuating body is surrounded by the guide body and, in particular, if the pivot bearing body engages around the guide body.

No further details have been provided with regard to the arrangement of the rotation blocking bodies relative to the actuating body.

In principle, the rotation blocking bodies could be arranged in such a way that they are surrounded by the actuating body.

For the spatial structure of the trailer coupling according to the invention, it has also proven to be advantageous if the rotation blocking bodies are arranged around the actuating body.

It has proven to be particularly advantageous in terms of structure if the pivot bearing body forms an outer body which surrounds the guide body on the outside and which is arranged non-displaceably relative to the guide body in the direction of the pivot axis, and if, in particular, the pivot bearing body forms an outer body which surrounds at least a partial region of the rotation blocking unit on the outside and which is arranged such that it cannot be displaced relative to the guide body in the direction of the pivot axis, so that the pivot bearing body does not perform any movement in the direction of the pivot axis during the transition of the rotation blocking bodies from the rotation blocking position to the release position and vice versa, but can be arranged non-displaceably in the direction of the pivot axis.

Such an arrangement of the pivot bearing body has the advantage of a favorable spatial structure of the pivot bearing unit itself and the advantage of a relatively simple sealing of the pivot bearing unit, since the pivot bearing body does not perform any movements in the axial direction of the pivot axis.

Preferably, a seal encircling the pivot axis is provided between a housing of the pivot bearing unit and at least one end face of the outer body and is used to seal against the ingress of dirt and moisture.

In such a solution, the pivot bearing body simultaneously represents the outer body protecting and surrounding the guide body, and the fact that the outer body is arranged so that it cannot be displaced relative to the guide body in the direction of the pivot axis means in particular that a simple seal can be realized between the outer body and the pivot bearing unit.

A particularly favorable structural solution is one in which the pivot bearing body forms an outer body that surrounds a partial region of the rotation blocking device on the outside and is arranged non-displaceably relative to the guide body in the direction of the pivot axis.

In particular, it is provided that the rotation blocking bodies is moveable from the release position to the rotation blocking position by the actuating body.

Preferably, the actuating body is configured in such a way that in the release position it permits the release position of the rotation blocking bodies.

In particular, a further configuration of the actuating body ensures that in the rotation blocking position it holds the rotation blocking bodies in their rotation blocking position.

In order to ensure that the rotation blocking bodies always move into their rotation blocking position, in particular when the actuating body is not actively actuated, it is preferably provided that the actuating body is acted upon by an elastic energy store in the direction of its rotation blocking position.

In order to be able to move the actuating body from the rotation blocking position to the release position, it is preferably provided that the actuating body is moveable from the rotation blocking position to the release position by an actuating device.

In particular, such a movement of the actuating body by the actuating device takes place against the action of the energy store, i.e., the actuating device counteracts the action of the energy store and must therefore overcome the forces applied by the elastic energy store.

Particularly in the case of a rotatable actuating body, it is preferable that the actuating device is used to rotate the actuating body in the opposite direction to the rotational direction caused by the elastic energy store.

In principle, such an elastic energy store can be arranged at several locations.

In terms of structure, it is particularly favorable if the elastic energy store is arranged within the guide body.

Another structurally favorable solution is for the elastic energy store to be arranged on one side of the actuating body.

In this case, the elastic energy store can be advantageously coupled with the actuating element.

A wide variety of solutions are conceivable with regard to the action on the actuating body.

For example, one advantageous solution is for the actuating device to have an output element that is coupled to the actuating body.

In principle, it would be possible to rigidly couple the output element and the actuating body to one another.

However, it is particularly advantageous if the output element and the actuating body are coupled to each other by means of an entrainment coupling device which permits a relative movement through a limited movement range, in particular a limited angle of rotation depending on the position of the output element and the position of the actuating body, in particular the rotational position of the latter.

The entrainment coupling device could be an elastic connecting member.

However, it is particularly simple if the entrainment coupling device has an entrainment-free release state and an entrainment state, i.e., either the release state or the entrainment state is present.

In conjunction with the previous solutions, the drive of the rotation blocking device, which makes it possible to realize a transition of the rotation blocking device from at least one rotation blocking position to a release position and vice versa, was explained only in general terms.

Furthermore, it is preferable that the actuating device for the rotation blocking device comprises a motorized drive unit.

A motorized drive unit associated exclusively with the actuating device for the rotation blocking device could be provided.

However, it is particularly advantageous if a motorized drive unit is provided as a pivot drive for executing the pivoting movement of the ball neck.

For example, it is conceivable to provide two motorized drives, wherein one motorized drive is provided for actuating the rotation blocking device and one motorized drive is provided for carrying out the pivoting movement of the ball neck.

In particular, since the rotation blocking device is always driven at times when no pivoting movement of the ball neck is required and, in addition, a pivoting movement of the ball neck always takes place when no drive of the rotation blocking device is required, it is conceivable to provide a switchover device that switches a supplied drive power, for example from a power source, alternately from one drive to the other drive, so that the drive power provided by a separate supply device, for example on the motor vehicle side, can be used either to actuate the rotation blocking device or to pivot the pivot bearing body.

In this case, however, a corresponding sensor system must be used to detect when the rotation blocking device is in the rotation blocking position or the release position and when the ball neck is in the position corresponding to the working position or the position corresponding to the rest position and to switch the drive power from one drive to the other according to the positions detected by the sensor system.

If the rotation blocking device is driven independently of the drive for the pivoting movement of the pivot bearing body, the problem arises that in the event of a malfunction it is difficult to find clear starting positions for both the pivoting movement of the ball neck and the rotation blocking device.

It is particularly expedient if an output element for driving the rotation blocking device and an output element for driving the pivoting movement of the ball neck are coupled by an epicyclic gearing driven by a drive element.

In this case, it is possible to drive the epicyclic gearing by a single motorized drive unit, in particular a single electric drive unit.

The epicyclic gearing is preferably a planetary gearing.

It is particularly expedient if the first output element of the epicyclic gearing acts as a pivot drive to swivel the ball neck between the working position and the rest position and the second output element of the epicyclic gearing acts as an actuator on the actuating body to move it from the rotation blocking position to the release position.

The epicyclic gearing is expediently configured in such a way that it allows a change between the output element for actuating the rotation blocking device and the output element for performing the pivoting movement of the ball neck.

In particular, the epicyclic gearing can be used in such a way that, depending on the inhibition of the output element for the rotation blocking device or the pivoting movement of the ball neck, the pivoting movement or the rotation blocking device is driven.

The advantage of using an epicyclic gearing is that such an epicyclic gearing allows a change from one output to the other output in a simple manner, and thus one drive unit, for example comprising an electric drive motor and possibly a transmission, is sufficient to alternately drive the movements of the actuating body by means of one output and to drive the pivoting movement of the ball neck between the working position and the rest position by means of the other output.

For example, it is provided that a ring gear of the epicyclic gearing can be driven by the motorized drive.

Furthermore, it is expediently provided that a ring gear of the epicyclic gearing is coupled to the output for the rotation blocking device.

Furthermore, it is expediently provided that a planet gear carrier of the epicyclic gearing is coupled to the output for the pivoting movement.

In order to drive either the rotation blocking device or the pivoting movement in an epicyclic gearing which is driven by a single motorized drive, it is advantageously provided that the pivoting movement or the rotation blocking device is driven depending on whether the drive of the rotation blocking device or the pivoting movement is inhibited.

Such an inhibition of the pivoting movement or the rotation blocking device can be realized in different ways.

The pivoting movement can be inhibited in a simple way by the possibility of locking the ball neck relative to the pivot bearing unit, so that the pivoting movement is necessarily inhibited when it is locked.

The drive of the rotation blocking device can be inhibited in a wide variety of ways.

A particularly favorable solution is that a stop is provided in the release position to inhibit the drive of the rotation blocking device.

A wide variety of solutions are conceivable with regard to the arrangement of the epicyclic gearing.

A particularly compact solution provides for the epicyclic gearing to be arranged coaxially to the pivot axis in the pivot bearing unit.

Furthermore, it is preferable that the epicyclic gearing is arranged on a side of the actuating element of the rotation blocking device facing the motorized drive.

It is particularly advantageous for the compact structure if, viewed in the direction of the pivot axis, the epicyclic gearing is driven on one side by the motorized drive unit and has an output for the actuating element on the opposite side.

Thus, the epicyclic gearing is preferably arranged between the motorized drive unit and the actuating element when viewed in the direction of the pivot axis.

Furthermore, the epicyclic gearing, the elastic energy store and the actuating element are preferably arranged in succession in the direction of the pivot axis, in particular within the pivot bearing unit.

The above description of solutions according to the invention thus comprises, in particular, the various combinations of features defined by the following consecutively numbered embodiments:
1. A trailer coupling, comprising a ball neck (10) which is moveable between a working position (A) and a rest position (R), is connected at a first end to a pivot bearing unit (20) and carries a coupling ball (18) at a second end, the ball neck (10) being pivotable about a pivot axis (22) between the working position (A) and the rest position (R) by means of the pivot bearing unit (20) when a pivoting movement is carried out, and a rotation blocking device (50) acting between a guide body (40) and a pivot bearing body (14) of the pivot bearing unit (20), having on the one hand at least two rotation blocking units (80), each of which has a rotation blocking body (54) which is guided movably in a guide direction (58) by means of a guide receptacle (56) of the guide body (40) and which is movable in the guide direction (58) by a pushing surface (66) extending transversely to the guide direction (58) and provided on an actuating body (52), and having on the other hand at least two receptacles (60), wherein the rotation blocking bodies (54) of all rotation blocking units (80) are configured to be moved and acted upon in the guide direction (58) by a movement of the actuating body (52) in an actuating direction (72) and wherein the rotation blocking bodies (54) of all rotation blocking units (80) are configured to be brought into a rotation blocking position in the working position (A) by a movement in the guide direction (58) and in this position each rotation blocking body (54) comes into engagement with one of the receptacles (60) in each case in order to block a pivoting movement of the pivot bearing body (14) and of the guide body (40) relative to one another about the pivot axis (22), and is configured to be brought into a release position, and in this position is disengaged from the respective receptacle (60) and releases the relative movement between the pivot bearing body (14) and the guide body (40), wherein in all intended relative pivot positions between the pivot bearing body (14) and the guide body (40), including the rest position (R) and excluding the working position (A), a movement of the actuating body (52) in the actuating direction (72) and consequently also a force-loaded engagement of the rotation blocking bodies (54) of each of the rotation blocking units (80) into one of the receptacles (60) in each case is blocked, wherein a multiple blocking device (270) is provided, which comprises a blocking body (272) which is configured to be moved into a rest position blocking position blocking the pivot bearing body (14) and the guide body (40) relative to each other in the rest position (R), into a securing position securing the actuating body (52) in the rotation blocking position, and into an intermediate position lying between the rest position blocking position and the securing position.
2. A trailer coupling in accordance with embodiment 1, wherein the blocking body (272) is guided on the guide body (40) of the pivot bearing unit (20).
3. A trailer coupling in accordance with embodiment 1 or 2, wherein the blocking body (272) is guided in a guide (274) arranged on the guide body (40).
4. A trailer coupling in accordance with the preceding embodiments, wherein the guide (274) for the blocking body (272) is arranged in a wall region (104) of the guide body (40) adjacent to the actuating body (52) and the pivot bearing body (14).
5. A trailer coupling in accordance with embodiment 3 or 4, wherein the blocking body (272) is movable in the guide (274) in a direction approximately parallel to the pivot axis (22).
6. A trailer coupling in accordance with the preceding embodiments, wherein the blocking body (272) in the rest position blocking position engages in a receptacle (284) in the pivot bearing body (14).
7. A trailer coupling in accordance with the preceding embodiments, wherein the blocking body (272) in the securing position engages into a receptacle (282) in the actuating body (52).
8. A trailer coupling in accordance with the preceding embodiments, wherein the blocking body (272) is arranged in the intermediate position between the receptacle (282) in the actuating body (52) and the receptacle (284) in the pivot bearing unit (14).
9. A trailer coupling in accordance with embodiments 3 to 8, wherein the blocking body (272), starting both in the securing position and in the rest position blocking position and guided by the guide (274), engages in each case with one end (276, 278) in the respective receptacle (282, 284).
10. A trailer coupling in accordance with the preceding embodiments, wherein the blocking body (272) is fixable in the securing position, the intermediate position and the rest position blocking position by a blocking actuating device (280).
11. A trailer coupling in accordance with embodiment 10, wherein the blocking actuating device (280) comprises a camming guide (290) and a cam follower (292) which can be moved thereby and which is coupled to the blocking body (272).
12. A trailer coupling in accordance with embodiment 11, wherein the cam follower (292) is movable by the camming guide (290) approximately parallel to the pivot axis (22).
13. A trailer coupling in accordance with embodiment 11 or 12, wherein the camming guide (290) is movable transversely to the pivot axis (22).
14. A trailer coupling in accordance with embodiments 11 to 13, wherein the camming guide (290) is movable by the blocking actuating device (280).
15. A trailer coupling in accordance with embodiment 14, wherein the blocking actuating device (280) comprises a body (142) carrying the camming guide (290) and movable in rotation relative to the cam follower (292).
16. A trailer coupling in accordance with embodiments 11 to 15, wherein the camming guide (290) has at least one camming path (312, 314) acting on the cam follower (292).
17. A trailer coupling in accordance with embodiments 11 to 16, wherein the camming guide (290) has two camming paths (312, 314) acting on the cam follower (292) and guiding it between them.
18. A trailer coupling in accordance with embodiment 17, wherein both camming paths (312, 314) together fix the cam follower (292) in a position predetermining the securing position.
19. A trailer coupling in accordance with embodiment 17 or 18, wherein both camming paths (312, 314) together fix the cam follower (292) in a position predetermining the rest position blocking position.
20. A trailer coupling in accordance with embodiments 17 to 19, wherein a first camming path (312) comprises a path portion (312b) moving the cam follower (292) from the position defining the securing position to a position defining the intermediate position.

21. A trailer coupling in accordance with embodiments 17 to 20, wherein the first camming path (312) comprises a path portion (312d) moving the cam follower (292) from the position defining the intermediate position in the direction of and into a position corresponding to the rest position blocking position.
22. A trailer coupling in accordance with embodiment 21, wherein the path portion (312d) acting in the direction of the position corresponding to the rest position blocking position acts resiliently on the cam follower (292) in this direction.
23. A trailer coupling in accordance with embodiment 22, wherein the path portion (312d) is formed by a resiliently movable portion of the first link path (312).
24. A trailer coupling in accordance with embodiment 23, wherein, in the position corresponding to the rest position blocking position, the cam follower (292) is fixed between the resiliently movable path portion of the first camming path (312) in cooperation with the second camming path (314).
25. A trailer coupling in accordance with embodiments 17 to 24, wherein the second camming path (314) has a path portion (314b) which moves the cam follower (292) from the position corresponding to the rest position blocking position to a position corresponding to the intermediate position.
26. A trailer coupling in accordance with embodiments 17 to 25, wherein the second camming path (314) has a path portion (314d) which moves the cam follower (292) from the position corresponding to the intermediate position to a position corresponding to the securing position.
27. A trailer coupling in accordance with embodiments 17 to 26, wherein the first camming path (312) is effective by a movement of the camming guide (290) in a first rotational direction (322), and in that the second camming path (314) is effective by a movement of the camming guide in a rotational direction (324) opposite to the first rotational direction (322).
28. A trailer coupling in accordance with embodiment 27, wherein the blocking actuating device (280) is drivable by an actuating device (180) for the rotation blocking device (50).
29. A trailer coupling in accordance with embodiment 28, wherein the blocking actuating device (280) is coupled to the actuating device (180).
30. A trailer coupling in accordance with embodiment 28 or 29, wherein the camming path (290) is arranged on a rotatable body (142) of a planetary gearing (130) of the actuating device (180) for the rotation blocking device (50).
31. A trailer coupling in accordance with embodiment 30, wherein the camming path (290) is arranged on a ring gear (142) of a planetary gearing (130) of the actuating device (180).
32. A trailer coupling in accordance with the preceding embodiments, wherein the multiple blocking device (270) has a sensor unit (300) detecting the positions of the blocking body (272).
33. A trailer coupling in accordance with embodiment 32, wherein the sensor unit (300) detects the securing position, the rest position blocking position and the intermediate position.
34. A trailer coupling in accordance with embodiment 32 or 33, wherein the sensor unit (300) is configured in such a way that it distinguishes at least the intermediate position from the securing position and the rest position blocking position, in particular distinguishes all these positions from one another.
35. A trailer coupling in accordance with embodiments 32 to 34, wherein the sensor unit (300, 300′) comprises at least one push-button (301), in particular two push-buttons (301a, 301b).
36. A trailer coupling in accordance with embodiments 32 to 35, wherein the sensor unit (300″) comprises a magnetic field sensor (301″), in particular a magnetic field sensor (301″) detecting a course of a magnetic field (298) in space.
37. A trailer coupling in accordance with preceding embodiments 11 to 36, wherein the cam follower (292) is coupled to the blocking body (272) by means of a transmission element (294).
38. A trailer coupling in accordance with embodiment 37, wherein the transmission element (294) is coupled to a sensor actuating element (296).
39. A trailer coupling in accordance with the preceding embodiments, wherein blocking surfaces (90) extend between the receptacles (60), against which blocking surfaces the rotation blocking bodies (54) are placeable and from which the receptacles (60) extend, in that the rotation blocking units (80) and the receptacles (60) are arranged around the pivot axis (22) at angular spacings (W) from one another in such a way that, in all provided relative pivot positions between pivot bearing body (14) and guide body (40), including the rest position (R) and apart from the working position (A), the rotation blocking body (54) of at least one of the rotation blocking units (80) is opposite one of the blocking surfaces (90), and the blocking surfaces (90), in particular when a force is applied to the actuating body (52), block a movement of the actuating body (52) in the actuating direction (72) and consequently also a force-loaded engagement of the rotation blocking bodies (54) of each of the rotation blocking units (80) into one of the receptacles (60).
40. A trailer coupling in accordance with the preceding embodiments, wherein the rotation blocking units (80) are arranged at angular spacings (W) around the pivot axis (22) to form a rotation blocking configuration, in that the receptacles (60) are arranged at the same angular spacings (W) around the pivot axis (22) as the rotation blocking units (80) in order to form a receptacle configuration, in that the rotation blocking configuration and the receptacle configuration in the working position (A) are congruent with one another, so that the rotation blocking bodies (54) can engage in the receptacles (60), and in that the angular spacings (W) between the rotation blocking units (80) of the rotation blocking configuration and the angular spacings between the receptacles (60) of the receptacle configuration are selected such that the rotation blocking configuration and the receptacle configuration are congruent with one another only in the working position (A).
41. A trailer coupling in accordance with preceding embodiments 39 or 40, wherein the angular spacings (W) of at least one of the rotation blocking units (80) are unequal to the rotation blocking units (80) arranged adjacent in a direction of revolution about the pivot axis (22) and to the rotation blocking units (80) arranged opposite to this direction of revolution, and in that in the working position (A) the receptacles (60) are arranged in such a way that the rotation blocking body (54) of each of the rotation blocking units (80) is configured to be brought into engagement with one of the receptacles (60), and in that in all relative pivot positions between pivot bearing body (14) and guide body (14) which are provided for operation and which lie outside the working position (A), including the rest position (R), the rotation blocking body (54) of at least one of the rotation blocking units (80) is located opposite a blocking surface (90) running between the receptacles (60), and the blocking surface (90) blocks a movement of the actuating body (52) from the release position into the rotation blocking position, in particular when force is applied to the actuating body (52).
42. A trailer coupling in accordance with preceding embodiments 39 to 41, wherein the blocking surfaces (90) run facing the rotation blocking bodies (54) of the rotation blocking units (80).
43. A trailer coupling in accordance with preceding embodiments 39 to 42, wherein the blocking surfaces (90) run in a defined radius around the pivot axis (22).
44. Trailer coupling in accordance with preceding embodiments 39 to 43, wherein the blocking surfaces (90) run as far as the opening edges (92) of the receptacles (60) and merge into these.
45. A trailer coupling in accordance with embodiment 44, wherein the opening edges (92) of the receptacles (60) lie at the same radial spacing from the pivot axis (22) as the blocking surfaces (90).
46. A trailer coupling in accordance with preceding embodiments 39 to 45, wherein at least one of the rotation blocking bodies (54) of the rotation blocking units (80) abuts in a force-loaded manner against one of the blocking surfaces (90) during a pivoting movement of the pivot bearing body (14) in the direction of the working position (A), in particular by the action of the actuating body (52).
47. A trailer coupling in accordance with preceding embodiments 39 to 46, wherein the rotation blocking bodies (54) abut in a force-loaded manner against the blocking surfaces (90) before reaching the working position (A) and then enter the receptacles (60), abutting in a force-loaded manner against opening edges (92) of the receptacles (60).
48. A trailer coupling in accordance with preceding embodiments 39 to 47, wherein the receptacles (60) extend from the blocking surfaces (90) in the guide direction (58), in particular with at least one component in the radial direction to the pivot axis (22).
49. A trailer coupling in accordance with preceding embodiments 39 to 48, wherein the receptacles (60) and the blocking surfaces (90) are arranged facing the guide body (40).
50. A trailer coupling in accordance with the preceding embodiments, wherein the guide body (40) is a part of the pivot bearing unit (20) arranged fixed to the vehicle.
51. A trailer coupling in accordance with the preceding embodiments, wherein all the guide receptacles (56) for the rotation blocking bodies (54) of the rotation blocking units (80) are arranged in the guide body (40), and/or in that in particular the guide direction (58) runs with at least one component in the radial direction to the pivot axis (22), and/or in that in particular the guide body (40) has a guide sleeve (44) with guide receptacles (56) for the rotation blocking bodies (54) of the rotation blocking units (80), and in that in particular the rotation blocking bodies (54) are guided by the guide body (40) adjoining the pivot bearing body (14) in the radial direction.
52. A trailer coupling in accordance with the preceding embodiments, wherein a pivot bearing is provided between the guide body (40) and the pivot bearing body (14).
53. A trailer coupling in accordance with the preceding embodiments, wherein the actuating body (52) is guided movably relative to the guide body (40), in that in particular the actuating body (52) is arranged rotatably about the pivot axis (22) and in particular has wedge surfaces (66) extending over an angular range about the pivot axis (22) and varying parallel to the guide direction (58), preferably combined with retraction receptacles (62).
54. A trailer coupling in accordance with the preceding embodiments, wherein the receptacles (60) and the blocking surfaces (90) are arranged on the pivot bearing body (14).
55. A trailer coupling in accordance with the preceding embodiments, wherein the actuating body (52) is surrounded by the guide body (40), and in that in particular the pivot bearing body (14) engages around the guide body (40), in that in particular the rotation blocking bodies (54) are arranged around the actuating body (52).
56. A trailer coupling in accordance with the preceding embodiments, wherein the pivot bearing body (14) forms an outer body which surrounds the pivot bearing unit (20) on the outside and is arranged non-displaceably relative to the pivot bearing unit (20) in the direction of the pivot axis (22), and in that, in particular, the pivot bearing body (14) forms an outer body which surrounds at least a partial region of the rotation blocking unit (50) on the outside and which is arranged non-displaceably relative to the guide body (40) in the direction of the pivot axis (22).
57. A trailer coupling in accordance with the preceding embodiments, wherein the actuating body (52) is acted upon by an elastic energy store (114) in the direction of its rotation blocking position, in that in particular the actuating body (52) is moveable from the rotation blocking position into the release position by an actuating device (180), in that in particular the actuating body (52) is moveable by the actuating device (180) against the load application by the energy store (114), in that in particular the actuating body (52) is moveable by the actuating device (180) in the opposite direction to the actuating direction (72) caused by the elastic energy store (114).
58. A trailer coupling in accordance with the preceding embodiments, wherein the actuating device (180) has an output element (142) which is coupled to the actuating body (52), in that in particular the output element (142) and the actuating body (52) are coupled to one another by means of an entrainment coupling device (156, 158), in that in particular the entrainment coupling device (156, 158) has an entrainment-free release state and an entrainment state, in that in particular the actuating device (180) for the rotation blocking device (50) comprises a motorized drive unit, in that in particular the motorized drive unit (182) is also provided as a pivot drive for executing the pivoting movement of the pivot bearing body (14), in that in particular an output element (142) for driving the rotation blocking device (50) and the output element (152) and for driving the pivoting movement of the pivot bearing body (14) are coupled by an epicyclic gearing (130).

Further features and advantages of the solution according to the invention are the subject of the following description and the graphical depiction of an exemplary embodiment.

### BRIEF DESCRIPTION OF THE DRAWINGS

FIG. 1 is a rear view of a motor vehicle with a trailer coupling according to the invention;

FIG. 2 is a plan view of a first exemplary embodiment of a trailer coupling according to the invention, looking in the direction of travel towards the trailer coupling mounted on the rear of a vehicle, wherein the trailer coupling is in its working position;

FIG. 3 is a plan view of the trailer coupling in FIG. 2 in the direction of the pivot axis;

FIG. 4 is a view corresponding to FIG. 2 of the trailer coupling in the rest position;

FIG. 5 is a plan view of the trailer coupling according to the trailer coupling according to FIG. 4 in the rest position, in the direction of the pivot axis;

FIG. 6 is a sectional representation along line 6-6 in FIG. 3.

FIG. 7 shows a section along line 7-7 in FIG. 6 in the working position;

FIG. 8 is a sectional representation similar to FIG. 7 in the release position with the actuating body rotated maximally;

FIG. 9 is a representation similar to FIG. 8 with the pivot bearing body slightly pivoted out of the working position, with the actuating body rotated maximally;

FIG. 10 is a representation similar to FIG. 8 with the actuating body under the action of the torsion spring;

FIG. 11 is a representation similar to FIG. 8 of a pivot position of the pivot bearing body with increasing pivoting movement in the direction of the rest position;

FIG. 12 is a representation similar to FIG. 8 of a pivot position of the pivot bearing body with increasing pivoting movement in the direction of the rest position;

FIG. 13 is a representation similar to FIG. 8 of a pivot position of the pivot bearing body with increasing pivoting movement in the direction of the rest position;

FIG. 14 is a representation similar to FIG. 7 in the rest position;

FIG. 15 shows a section along line 15-15 in FIG. 6 without support plate and retaining ring;

FIG. 16 is a perspective representation of a ring gear and a drive sleeve interacting therewith;

FIG. 17 is a perspective exploded representation of the pivot bearing body with the cover;

FIG. 18 shows an enlarged section similar to FIG. 6 in the working position with the blocking body in the securing position;

FIG. 19 shows an enlarged section according to FIG. 6 with the blocking body in the intermediate position;

FIG. 20 shows an enlarged section similar to FIG. 18 in the rest position with the blocking body in the rest position blocking position;

FIGS. 21a-21c are views in the starting position of the ring gear wherein:

FIG. 21a is a perspective representation of the interaction of the ring gear with the blocking actuating device and with the rotation blocking device;

FIG. 21b is a plan view of the ring gear of the planetary gearing from the side of the drive sleeve;

FIG. 21c is a perspective representation of the interaction of the ring gear in the position according to FIG. 21b with detection of positions of a blocking body;

FIGS. 22a-22c are views in the first position of the ring gear rotated relative to the starting position after release of the securing position and with blocking body in the intermediate position and without action on the rotation blocking device, wherein:

FIG. 22a is a perspective representation of the interaction of the ring gear with the blocking actuating device and with the rotation blocking device;

FIG. 22b is a plan view of the ring gear of the planetary gearing from the side of the drive sleeve;

FIG. 22c is a perspective representation of the interaction of the ring gear in the position according to FIG. 22b with detection of positions of a blocking body;

FIGS. 23a-23c are views in a position of the ring gear rotated maximally relative to the starting position when the release position of the rotation blocking device is reached and with spring-loaded blocking body in the intermediate position, wherein:

FIG. 23a is a perspective representation of the interaction of the ring gear with the blocking actuating device and with the rotation blocking device;

FIG. 23b is a plan view of the ring gear of the planetary gearing from the side of the drive sleeve;

FIG. 23c is a perspective representation of the interaction of the ring gear in the position according to FIG. 23b with detection of positions of a blocking body;

FIGS. 24a-24c are views in a position of the ring gear rotated relative to the starting position when the rest position of the pivot bearing body and the rest position blocking position have been reached, wherein:

FIG. 24a is a perspective representation of the interaction of the ring gear with the blocking actuating device and with the rotation blocking device;

FIG. 24b is a plan view of the ring gear of the planetary gearing from the side of the drive sleeve;

FIG. 24c is a perspective representation of the interaction of the ring gear in the position according to FIG. 24b with detection of positions of a blocking body;

FIGS. 25a-25c are views in a position of the ring gear turned back relative to the starting position of FIG. 24 and deactivation of the rest position blocking position and transition to the intermediate position, wherein

FIG. 25a is a perspective representation of the interaction of the ring gear in the position according to FIG. 25b with a detection of positions of a blocking body;

FIG. 25b is a plan view of the ring gear of the planetary gearing from the side of the drive sleeve;

FIG. 25c is a perspective representation of the interaction of the ring gear in the position according to FIG. 25a with a securing device and with the rotation blocking device;

FIGS. 26a-26c are views in the starting position of the ring gear after a transition of the rotation blocking device into the rotation blocking position and after the securing position of the blocking body has been reached, wherein:

FIG. 26a is a perspective representation of the interaction of the ring gear in the position according to FIG. 25b with detection of positions of a blocking body;

FIG. 26b is a plan view of the ring gear of the planetary gearing from the side of the drive sleeve;

FIG. 26c is a perspective representation of the interaction of the ring gear in the position according to FIG. 26a with a securing device and with the rotation blocking device;

FIGS. 27a-27c are views that show a second exemplary embodiment of a sensor unit with position indicating element, wherein:

FIG. 27a with detection of the securing position;

FIG. 27b with detection of the intermediate position;

FIG. 27c with detection of the rest position blocking position;

FIGS. 28a-28c are views that show a third exemplary embodiment of a sensor unit with position indicating element, wherein

FIG. 28a with detection of the securing position;

FIG. 28b with detection of the intermediate position;

FIG. 28c with detection of the rest position blocking position.

### DETAILED DESCRIPTION OF THE INVENTION

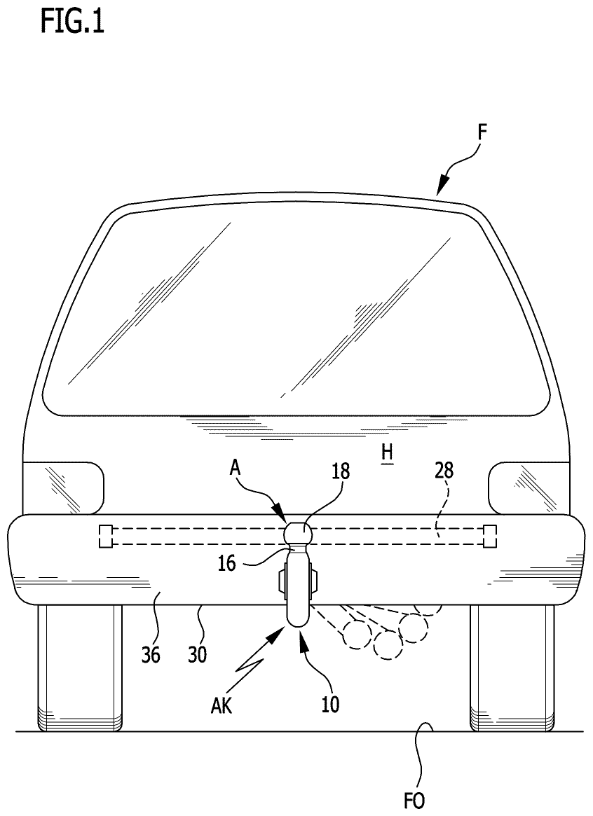

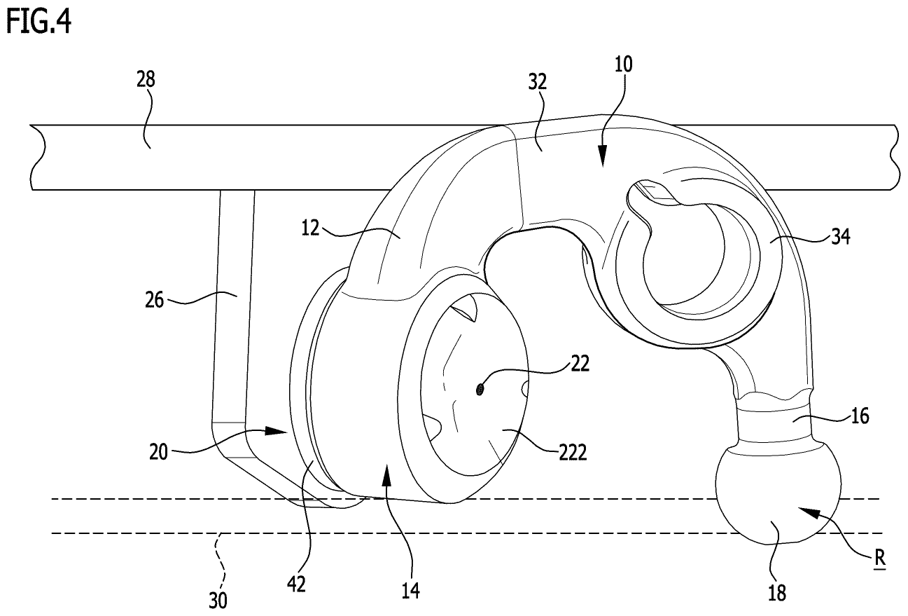

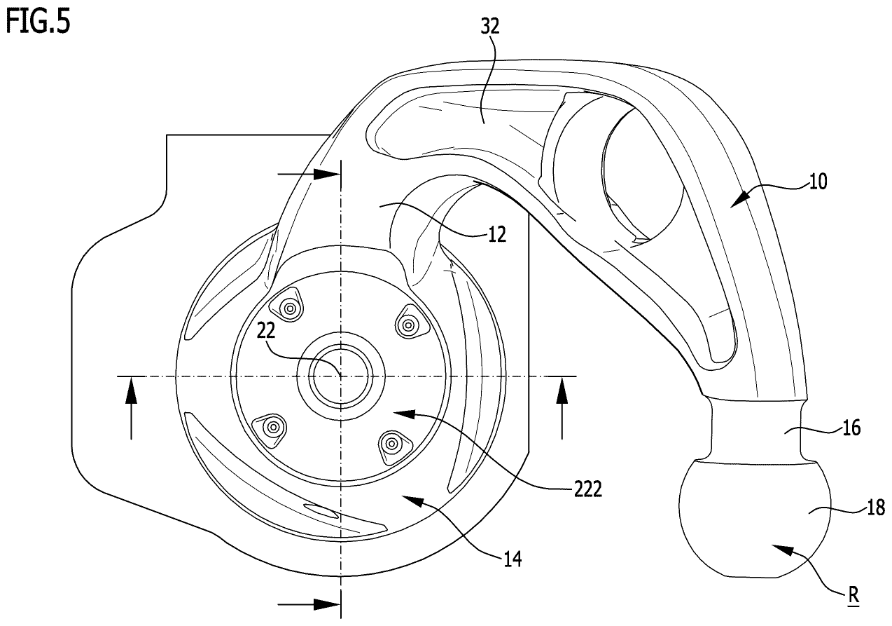

A first exemplary embodiment of a trailer coupling AK for a motor vehicle according to the invention, shown in FIGS. 1, 2 and 3 in an operating position A and in FIGS. 4 and 5 in a rest position R, comprises a ball neck designated as a whole by 10, which is held at a first end 12 on a pivot bearing unit 20 and at a second end 16 carries a coupling ball designated as a whole by 18, on which a coupling ball receptacle of a trailer can be fixed.

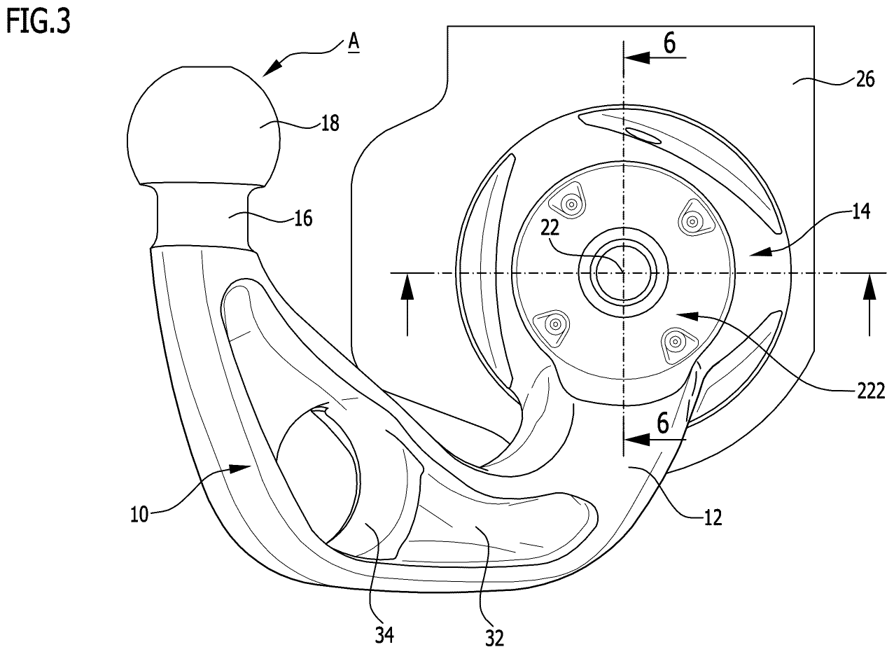

The ball neck 10 is mounted pivotably about a pivot axis 22 relative to a carrier 24, fixed to the vehicle, by the pivot bearing unit designated as a whole by 20, wherein the carrier 24 preferably has a support plate 26 holding the pivot bearing unit 20, which preferably extends in a plane perpendicular to the pivot axis 22, and has a cross member 28, fixed to the vehicle, which can be fastened in a known manner to a rear region H of a vehicle body F, more specifically in such a way that the pivot bearing unit 20 and the carrier 24 lie on a side of a lower edge 30 of a bumper unit 36 facing away from a road surface FO and are covered by the bumper unit 36 (FIG. 3).

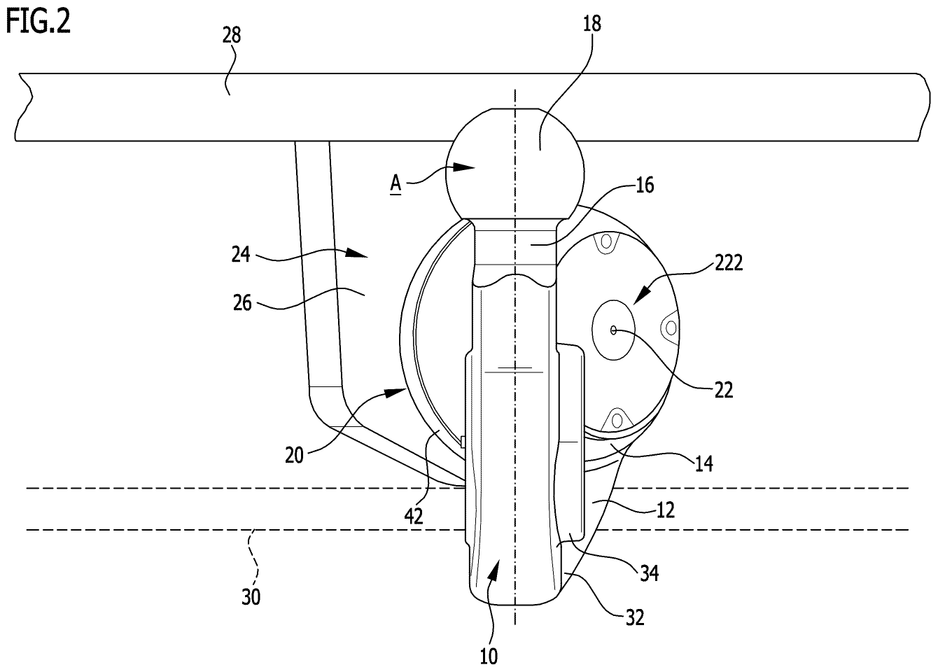

In the working position shown in FIGS. 1 and 2, the ball neck 10 engages below the lower edge 30 of the bumper unit 36 with a portion 32 adjoining the first end 12, so that the second end 16 and the coupling ball 18 together with a socket receptacle 34 are located on a side of the rear bumper unit 36 facing away from the vehicle body F, while in the rest position, both the pivot bearing unit 20 and the entire ball neck 10 together with the coupling ball 18 are covered by the rear bumper unit 36 so that they cannot be seen from behind.

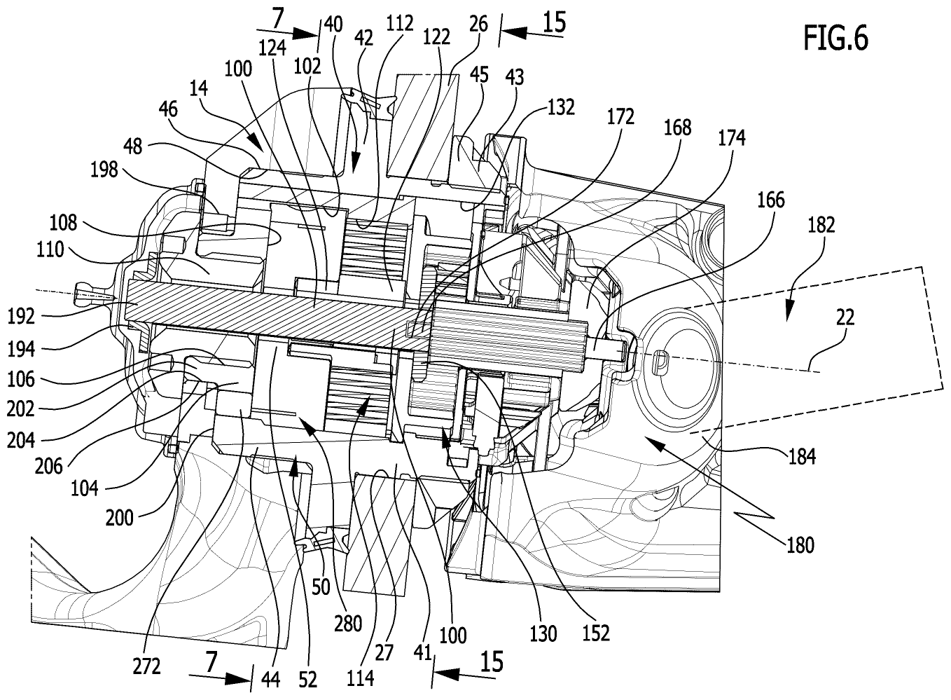

As shown in FIGS. 6 to 9, the pivot bearing unit 20 comprises a pivot bearing body 14 on the one hand and a guide body 40 on the other. For example, the guide body 40 is firmly connected to the support plate 26 by a flange 42 and a guide sleeve 44 extending from the flange 42 away from the support plate 26, on which the pivot bearing body 14 is rotatably mounted about the pivot axis 20, on which the ball neck 10 is held.

Alternatively, however, it is also conceivable to connect the pivot bearing body 14 firmly to the flange 42 and to arrange the ball neck on the guide body 40.

The guide sleeve 44 comprises a cylindrical outer surface 46, against which the pivot bearing body 14 abuts with a cylindrical inner surface 48 in order to obtain a rotation guide about the axis 22 about the pivot axis 22, so that the pivot bearing body 14 and the guide body 40 are rotatable relative to one another and thus the ball neck 10 is pivotable from the working position A into the rest position R and vice versa.

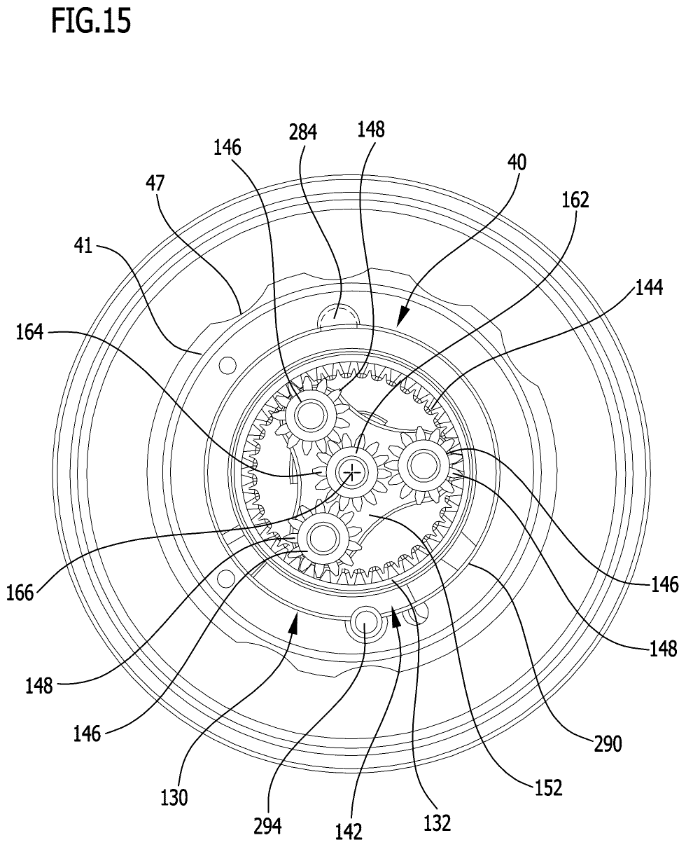

In the case of its fixed mounting, the guide body 40 comprises an extension 41 extending through an aperture 27 in the support plate 26, which extension carries a receptacle 43, following the extension 41 on a side opposite the flange 42, for a retaining ring 45 fixable to the extension, so that the guide body 40 is seated by the extension 41, due to its non-rotationally symmetrical but radially varying outer contour 47 (FIG. 15), in the correspondingly shaped aperture 27 in a rotationally fixed manner in the support plate 26 and is fixed to the latter by the flange 42 and the retaining ring 45, which abut on opposite sides of the support plate 26.

The guide body 40 thus forms the pivot bearing, fixed to the vehicle, for the pivot bearing body 14 due to its fixed connection with the support plate 26 and the carrier 24.

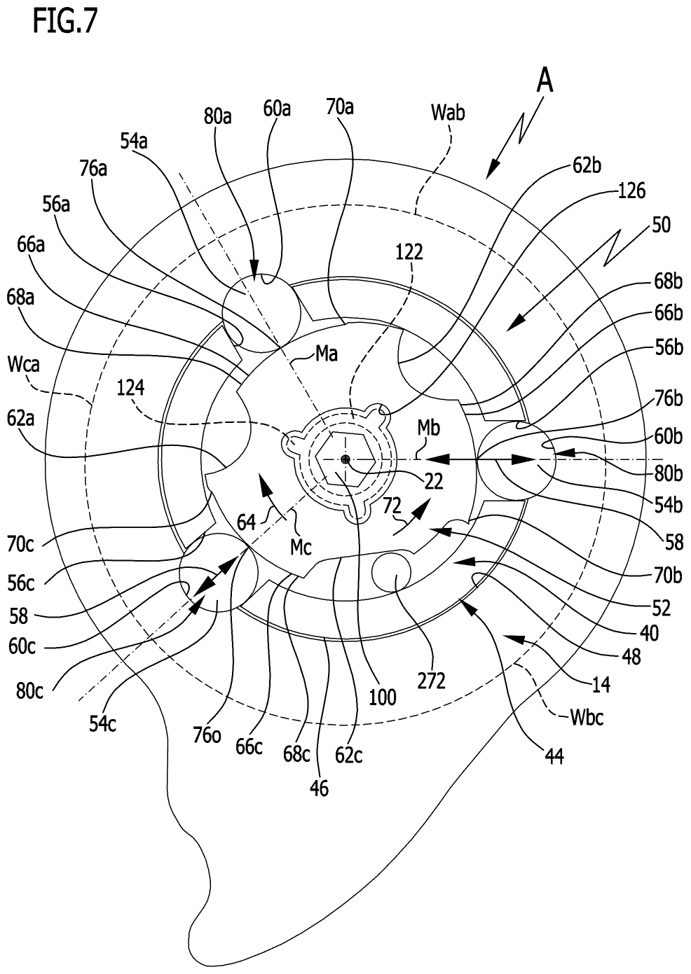

In order to fix the pivot bearing body 14 and the guide body 40 relative to one another in the working position A, the pivot bearing unit 20 is provided with a rotation blocking device (FIG. 7 to FIG. 14) designated as a whole by 50, which has an actuating body 52 and a plurality of rotation blocking bodies 54, which are configured to be acted upon by the actuating body 52 and each of which is guided in a guide receptacle 56 of the guide sleeve 44 so as to be movable in a guide direction 58 extending substantially radially to the pivot axis 22.

Preferably, at least the rotation blocking bodies 54 and the guide receptacles 56 are arranged symmetrically with respect to a geometric plane extending perpendicularly to the pivot axis 22 and intersecting the rotation blocking bodies 54, which geometric plane corresponds to the drawing plane in FIGS. 7 to 14.

Furthermore, starting from the inner surface 48 of the pivot bearing body 14, the rotation blocking device 50 comprises receptacles 60, which extend into the pivot bearing body, in particular in the radial direction relative to the pivot axis 22 and with which the rotation blocking bodies 54 are configured to be brought into engagement in the working position A, wherein the receptacles 60 have wall surfaces which are increasingly spaced apart from one another by a smaller spacing in the radial direction relative to the pivot axis 22.

If, for example, the rotation blocking device 50, as shown in conjunction with FIG. 7 to FIG. 14 in the first exemplary embodiment, comprises a set of three rotation blocking bodies 54a, 54b and 54c, the guide sleeve 44 has a corresponding set of three guide receptacles 56a, 56b and 56c, in which the rotation blocking bodies 54a, 54b and 54c are displaceably guided in the guide direction 58 extending substantially radially to the pivot axis 22, and the pivot bearing body 14 is provided with a set of receptacles 60a, 60b and 60c, with which the rotation blocking bodies 54a, 54b and 54c are configured to be brought into engagement in the working position A.

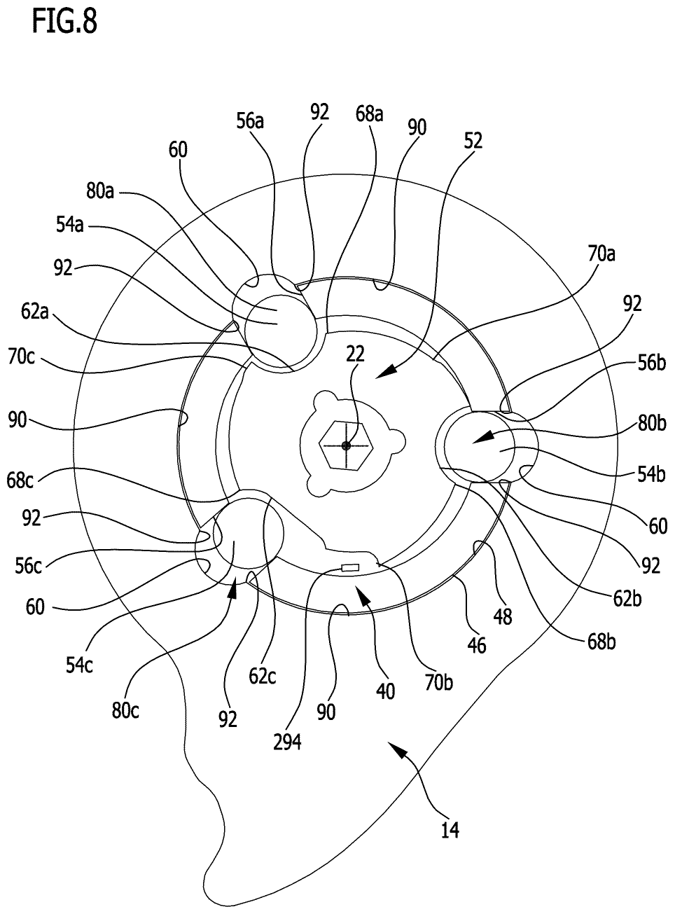

For suitable movement and positioning of the rotation blocking bodies 54 in the guide direction 58, the actuating body 52 is provided with a set, corresponding to the number of rotation blocking bodies 54, of, for example, a total of three, retraction receptacles 62a, 62b and 62c corresponding to the number of rotation blocking bodies 54 and three pushing surfaces 66a, 66b and 66c adjoining the retraction receptacles 62a, 62b, 62c in a direction of revolution 64, which pushing surfaces are formed as wedge surfaces acting radially to the pivot axis 22, wherein the rotation blocking bodies 54 in their release position can enter into the retraction receptacles 62a, 62b, 62c to such an extent (FIG. 8) so that they no longer protrude beyond the outer surface 46 of the guide sleeve 44, and wherein the pushing surfaces 66a, 66b, 66c each extend increasingly radially outwardly relative to the pivot axis 22 from a radially inner starting region 68a, 68b and 68c adjoining the respective retraction receptacles 62, with increasing extent in the direction of revolution 64, up to a radially outer end region 70a, 70b and 70c and thus act as wedge surfaces on the rotation blocking bodies 54 during a rotation movement of the actuating body 52 in order to move these rotation blocking bodies into their rotation blocking position.

Preferably, the pushing surfaces 66 extend as spiral or involute segments relative to the pivot axis 22.

In order to either hold the rotation blocking bodies 54 in their rotation blocking position by acting on them with the pushing surfaces 66 between the starting region 68 and the end region 70 or to allow them to enter into the retraction receptacles 62 in the release position, the actuating body 52 is also rotatable about the pivot axis 22, in particular coaxially thereto, and in such a way that either the set of retraction receptacles 62a, 62b and 62c faces the rotation blocking bodies 54 and, as shown in FIG. 8, in their inactive position or release position, enables them to enter into the retraction receptacles 62 in a radial direction towards the pivot axis 22 during the transition to the release position, in order to enable the respective rotation blocking bodies 54 to leave the receptacles 60 and together with the pivot bearing body 14 to be released with respect to a rotation about the pivot axis 22 relative to the guide body 40, so that the pivot bearing body 14 with the ball neck 10 is unhindered and freely rotatable relative to the guide sleeve 44, as shown in FIG. 8, wherein in this case the rotation blocking bodies 54 do not extend beyond the outer surface 46 of the guide sleeve 44.

A rotation of the actuating body 52 in a rotational direction 72 opposite to the direction of revolution 64 with the rotation blocking bodies 54 seated in the retraction receptacles 62 has the effect that the rotation blocking bodies 54 are moved out of the retraction receptacles 62 and initially sit on the starting regions 68 of the pushing surfaces 66 in the active position or rotation blocking position of the actuating body 52, but in the process enter into the receptacles 60, for example, and thus prevent the pivot bearing body 14 from rotating freely relative to the guide body 40 in its rotation blocking position.

If the actuating body 52 is rotated further in the rotational direction 72 in the opposite direction to the direction of revolution 64, the regions of the pushing surfaces 66 that are located increasingly radially outwardly relative to the pivot axis 22 act on the rotation blocking bodies 54 and thus increasingly press the rotation blocking bodies 54 in the working position A of the ball neck 10 into the receptacles 60a, 60b and 60c, (FIG. 7), in order to thus achieve a substantially play-free fixing of the pivot bearing body 14 relative to the guide body 40, in this case to the guide sleeve 44.

In the rotation blocking position of the rotation blocking bodies 54, the actuating body 52 is in its active position such that the rotation blocking bodies 54, as shown in FIG. 7, sit approximately on central regions 76, which lie between the starting regions 68 and the end regions 70, of the pushing surfaces 66 and are acted upon by these.

In order to enable the actuating body 52 to act optimally on each of the three rotation blocking bodies 54, it is provided that, in the active position, the actuating body 52 is centered according to the position of the rotation blocking bodies 54. In particular, the actuating body 52 is mounted in the guide sleeve 44 in such a way that the actuating body 52 can center itself within the guide body 40 due to the radial play relative to the position of the rotation blocking bodies 54 caused by manufacturing tolerances, wherein the self-centering of the actuating body 52 can deviate slightly from a coaxial arrangement relative to the geometric pivot axis 22.

Due to the self-centering, the rotation blocking bodies 54a, 54b and 54c act in the respective guide direction 58a, 58b and 58c with approximately equally large forces on the receptacles 60a, 60b and 60c, so that the reaction forces acting on the actuating body 52 are also approximately equally large.

Preferably, the rotation blocking bodies 54 are configured as balls, which thus abut against the actuating body 52 on the one hand and also against the receptacles 60 on the other.

Thus, there is only a rotatable bearing with play of the actuating body 52 relative to the pivot axis 22, which is primarily relevant when the actuating body 52 holds the rotation blocking bodies 54 in a release position in which the rotation blocking bodies 54 enter into the retraction receptacles 62 of the actuating body 52.

In order to cause the actuating body 52 to always move in the rotational direction 72 without external influence in such a way that the rotation blocking bodies 54 move in the direction of the rotation blocking position, the actuating body 52 is acted upon by a torsion spring 114 (FIG. 6), which on the one hand acts on the actuating body 52 and on the other hand is supported radially externally on the guide body 40.

The torsion spring 114 also causes the actuating body 52 to press the rotation blocking bodies 54 into the receptacles 60 in a force-loaded manner, and thus the pivot bearing body 14 is fixed without play, the freedom from play being maintained even if the geometry of the receptacles 60 changes due to the loads during operation by further rotation of the actuating body 52 in the rotational direction 72.

The, for example, three guide receptacles 56 and the rotation blocking bodies 54 arranged in these, as well as the retraction receptacles 62 respectively associated with these rotation blocking bodies 54 with the pushing surfaces 66 adjoining these in the actuating body 52 each form three rotation blocking units 80 and these are arranged around the pivot axis 22 at unequal angular spacings Wab, Wbc, Wca (in relation to the respective center axis Ma, Mb, Mc) relative to one another, whereby, in relation to the pivot axis 22 as the axis of rotation, a rotation blocking configuration of the rotation blocking units 80 only leads to a congruent arrangement of the rotation blocking units 80 when the rotation blocking configuration is rotated through 360°.

For example, the angular spacing Wab=120°, the angular spacing Wbc=137° and the angular spacing Wca=103°, which means that the deviation from equal angular spacings is 17°.

With three rotation blocking units, for example, deviations from equal angular spacings up to 30°or more are also possible, so that angular spacings of Wab=120°, Wbc=150° and Wca=90° are possible, for example.

Similarly, the receptacles 60 are each arranged relative to one another in relation to the pivot axis 22 in a receptacle configuration with the same angular spacings relative to one another, which also lead to a congruent arrangement of the respective receptacle configuration in relation to the pivot axis 22 only when rotating through 360°, so that in the working position this is congruent with the rotation blocking configuration, so that in the working position A, in each case a rotation blocking body 54 of one of the rotation blocking units 80 is opposite one of the receptacles 60 and can engage with the latter in the rotation blocking position, as shown in FIG. 7, as a result of which the pivot bearing body 14 can only be fixed in a rotationally fixed manner relative to the pivot bearing unit 20 (FIG. 7).

However, if the actuating body 52 is moved into the release position in the working position A against the force effect of the torsion spring 114, as described below, each of the rotation blocking bodies 54 of the respective rotation blocking unit 80 has the possibility of entering into the retraction receptacle 62 associated therewith and of leaving the respective receptacle 60, so that the pivot bearing body 14 is pivotable about the pivot axis 22 out of the working position (FIG. 8).

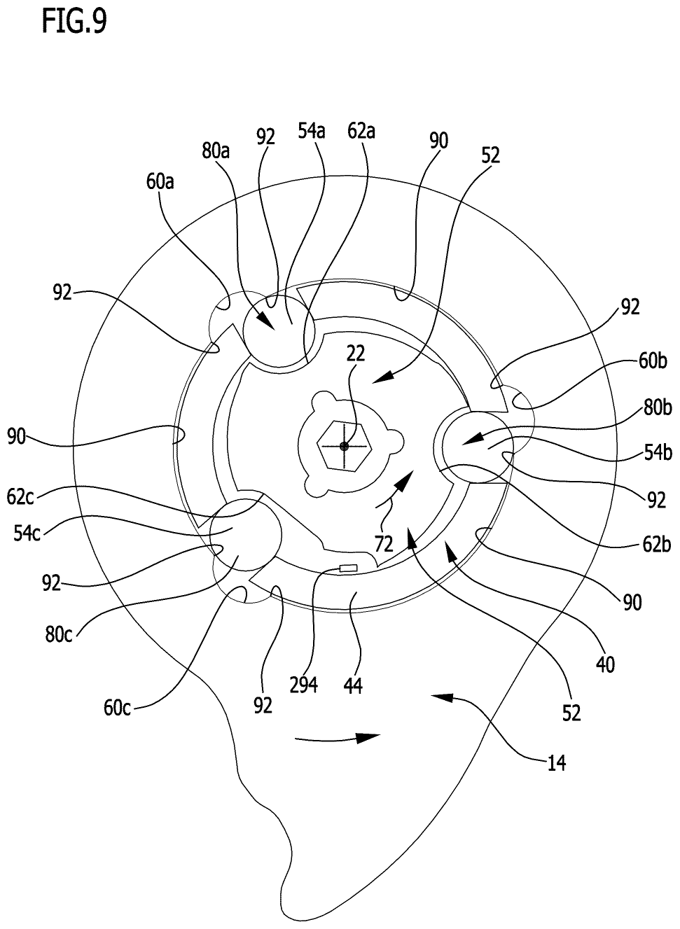

As soon as the pivot bearing body 14 has left the working position A (FIG. 9), the entirety of the rotation blocking units 80 arranged relative to the pivot axis 22 in the rotation blocking configuration can no longer engage with the entirety of the receptacles 60 arranged in the receptacle configuration, so that, when the actuating body 52 is acted upon in the rotational direction 72, the entirety of the rotation blocking units 54 seated in the retraction receptacles 62 can no longer engage in the entirety of the receptacles 60, since the rotation blocking bodies 54 can be loaded in the direction of the pivot bearing body 14 by the actuating body 52 loaded by the torsion spring 114 in the rotational direction 72, in particular by the curved base surfaces of the retraction receptacles 62 running at an angle to the guide direction 58, however, in each of the rotational positions of the pivot bearing body 14 lying outside the working position A, the entirety of the rotation blocking bodies 54 is never opposite a respective receptacle 60 from the entirety of the receptacles 60, and thus at least one of the rotation blocking bodies 54 is always blocked by one of the blocking surfaces 90 running between the receptacles 60, formed in the simplest case by the cylindrical inner surface 48 of the pivot bearing body 14, and thereby prevents rotation of the actuating body 52 in the rotational direction 72 caused by the torsion spring 114, so that the actuating body 52 is thereby held in the release position in all pivot positions of the pivot bearing body 14 outside the working position A, even when the torsion spring 114 acts in the rotational direction 72, and consequently can only move back into the rotation blocking position when the working position A is reached.

Preferably, the deviation of the rotation blocking configuration of the rotation blocking unit 80 and the receiving configuration of the receptacles 60 from a symmetrical configuration is such that when one of the rotation blocking units 80 is opposite one of the receptacles 60, so that the rotation blocking body 54 could engage with this receptacle 60, at least one, even better at least two, of the rotation blocking units 80 are offset in the rotational direction relative to the nearest receptacle 60 to such an extent that a point of contact of the rotation blocking body 54 associated with this rotation blocking unit 80 is already located on one of the blocking surfaces 90 and cannot come to lie in the region of one of the receptacles 60, so that reliable blocking of the actuating body 52, in particular when the actuating body 52 is acted upon by the torsion spring 114 in the rotational direction 72, is ensured by the blocking surfaces 90 which are effective in the release position.

If the actuating body 52 is acted upon with a rotational direction 64 opposite to the action of the torsion spring 114 and is rotated to the maximum, the rotation blocking bodies 54 lie with play between the respective blocking surface 90 and the retraction receptacles 62 in all pivot positions of the pivot bearing body 14, as shown in FIG. 9.

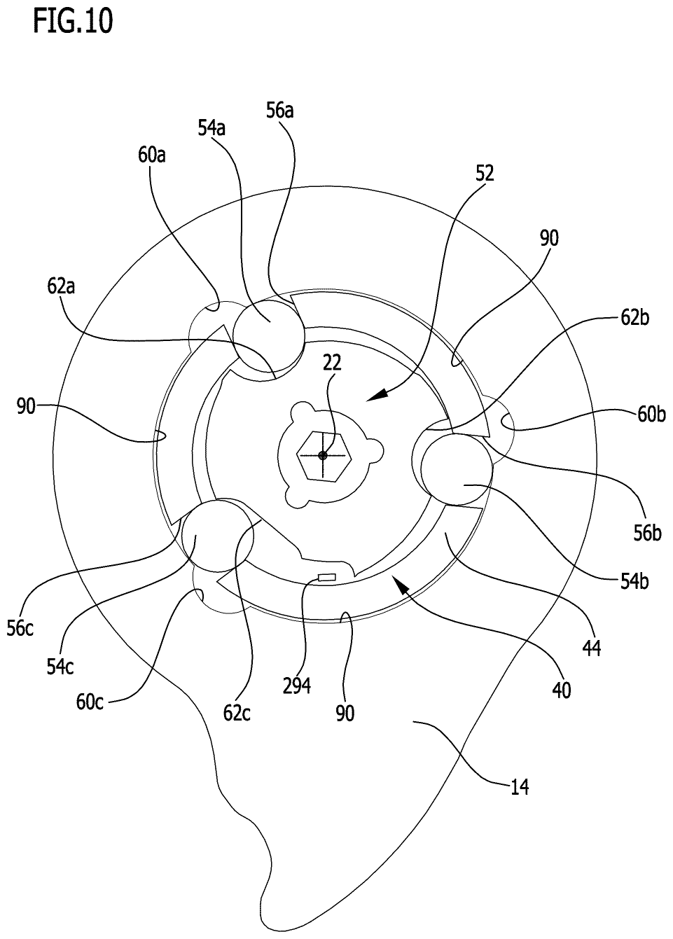

If, however, the effect of the torsion spring 114 dominates in the rotational direction 72, then conditions as shown in FIGS. 10 to 14 also exist in the respective pivot positions of the pivot bearing body 14 when pivoting from the working position A to the rest position R.

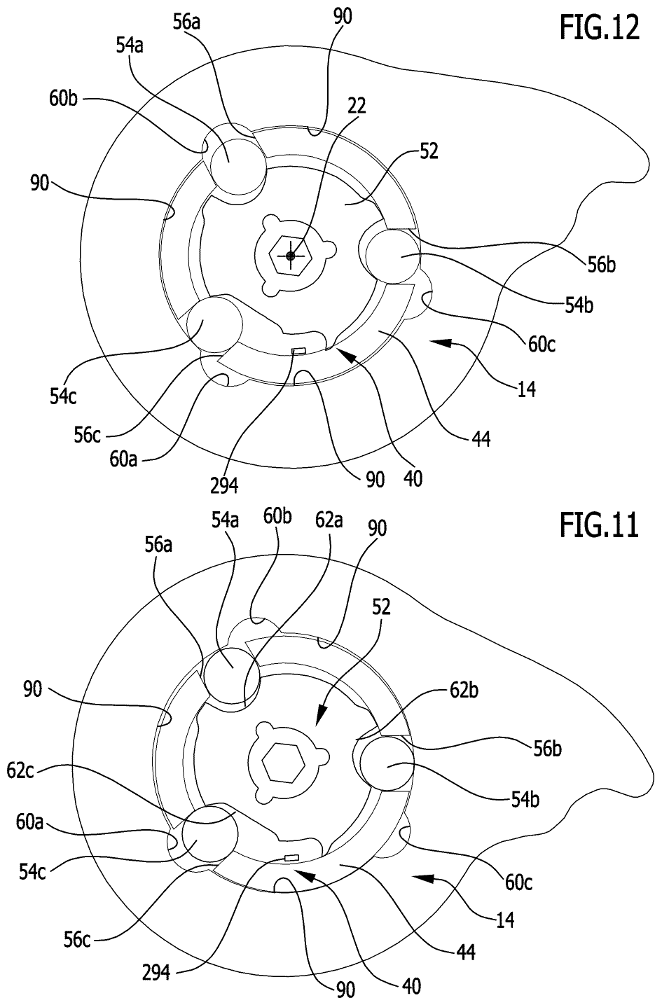

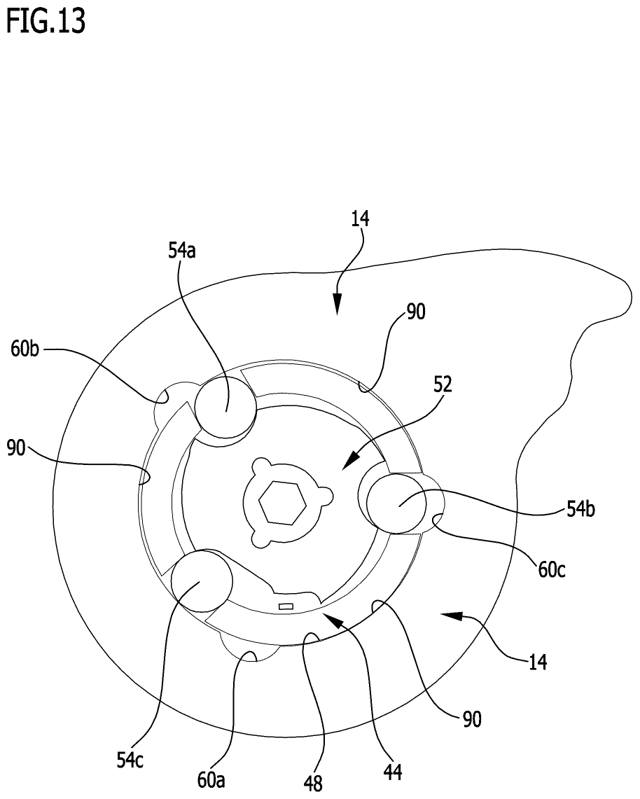

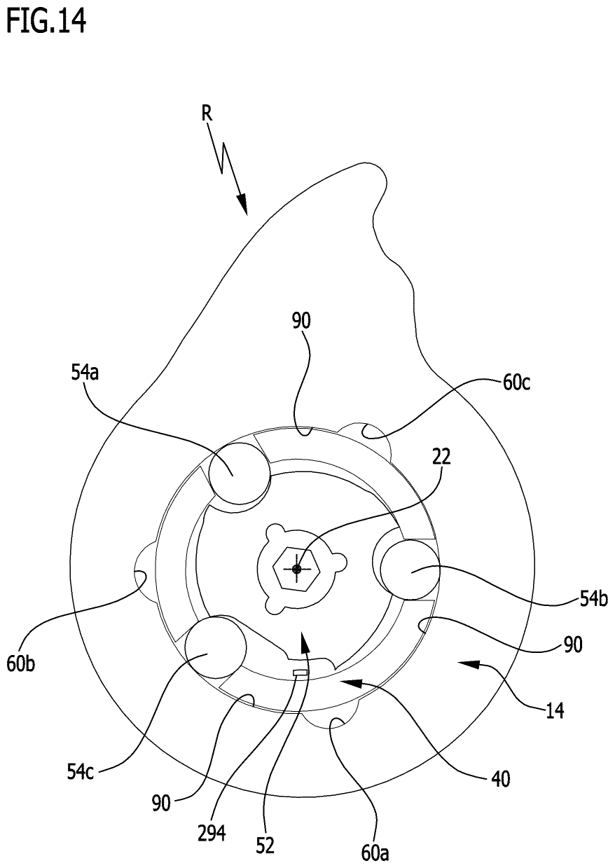

FIGS. 9 to 14 all show that the actuating body 52 is held in the release position in each of the pivot positions of the pivot bearing body 14 by at least two rotation blocking bodies 54, which abut against one of the blocking surfaces 90, and prevent one of the rotation blocking bodies 54, for example the rotation blocking body 54c in FIG. 11, the rotation blocking body 54a in FIG. 12, and the rotation blocking body 54b in FIG. 13, from engaging in the respective receptacle 60 aligned therewith.

In any case, the conditions according to FIGS. 9 to 14 exist when pivoting from the rest position R (FIG. 14) into the working position A, wherein, due to the contact of the rotation blocking bodies 54 with the blocking surfaces 90 according to FIG. 9 when pivoting back from the rest position R into the working position A in the sequence according to FIG. 14 to FIG. 9, the rotation blocking bodies 54 slide, with little noise generation, from the blocking surfaces 90 over the opening edges 92 of the receptacles 60, which directly and in particular steplessly adjoin them, into the receptacles 60 and move into the rotation blocking position according to FIG. 7.

The guide sleeve 44 preferably extends with a portion forming a receptacle 102 for the actuating body 52 between the flange 42 and a flange 104 terminating the guide sleeve 44 and extending radially to the pivot axis 22, which flange is preferably formed in one piece on the guide sleeve 44 and delimits the receptacle 102 for the actuating body 52, so that the actuating body 52 is guided radially relative to the pivot axis 22 through the receptacle 102 of the guide sleeve 44 and is guided axially in the direction of the pivot axis 22 by abutting against an inner side 108 of the flange 104.

The flange 104 also has a receptacle 106 coaxial with the pivot axis 22, into which receptacle an insert 110 is inserted, in particular screwed in, which insert is penetrated by a pivot drive shaft 100 and is seated in the receptacle 106.

On a side of the receptacle 102 for the actuating body 52 opposite the flange 104, the guide sleeve 44 forms, for example with a portion passing through the flange 42, a torsion spring receptacle 112, in which the torsion spring 114 is arranged in connection with the actuating body 52, which torsion spring on the one hand is fixed with an outer end in the torsion spring receptacle 112 and is connected with an inner end to a drive sleeve 122, which is coupled non-rotatably to the actuating body 52.

For this purpose, the drive sleeve 122, as shown in FIGS. 6, 7 and 16, is provided, for example, with extensions 124 which engage in corresponding recesses 126 in the actuating body 52 to produce a positively-locking connection.

Due to the fact that the torsion spring 114 acts on the drive sleeve 122, which is coupled to the actuating body 52 for conjoint rotation, the actuating body 52 is driven in the rotational direction 72 by the action of the torsion spring 114 on the drive sleeve 122, so that the actuating body 52 always acts in the rotational direction 72 when the torsion spring 114 acts unhindered on the drive sleeve 122, so that the actuating body has the tendency to move the rotation blocking bodies 54 radially outwards away from the pivot axis 22 in a force-loaded manner in the guide direction 58, wherein this movement is prevented by the blocking surfaces 90 in all provided pivot positions of the pivot bearing body 14, apart from the working position A, and consequently the rotation blocking bodies 54 are pressed into the receptacles 60 only in the working position A, thereby fixing the pivot bearing body 14 relative to the guide sleeve 44 in a rotationally fixed and, in particular, play-free manner.

In order to be able to move the rotation blocking bodies 54 into the release position, an action on the actuating body 52 is required in the opposite direction to the rotational direction 72 and thus also in the opposite direction to the action of the torsion spring 114.

For this purpose, the drive sleeve 122 is drivable by means of a planetary gearing 130 designated as a whole by 130 (FIG. 6), which is arranged in a gearing receptacle 132 of the guide sleeve 44, in particular coaxially to the pivot axis 22, which is arranged, for example, partially within the aperture 27 of the carrier plate 26 and preferably extends away from the aperture 27 of the carrier plate 26 on a side opposite the flange 42.

For its part, the planetary gearing 130 (FIG. 15) comprises a ring gear 142, which is guided in the gearing receptacle 132 and is provided with an internal toothing 144, with which planet gears 146 are engaged with their external toothing 148.

The planet gears 146 are rotatably held on a planet gear carrier 152, which in turn is connected to the pivot drive shaft 100 for conjoint rotation, so that the planet gear carrier 152 forms an output of the planetary gearing 130 for executing the pivoting of the ball neck 10.

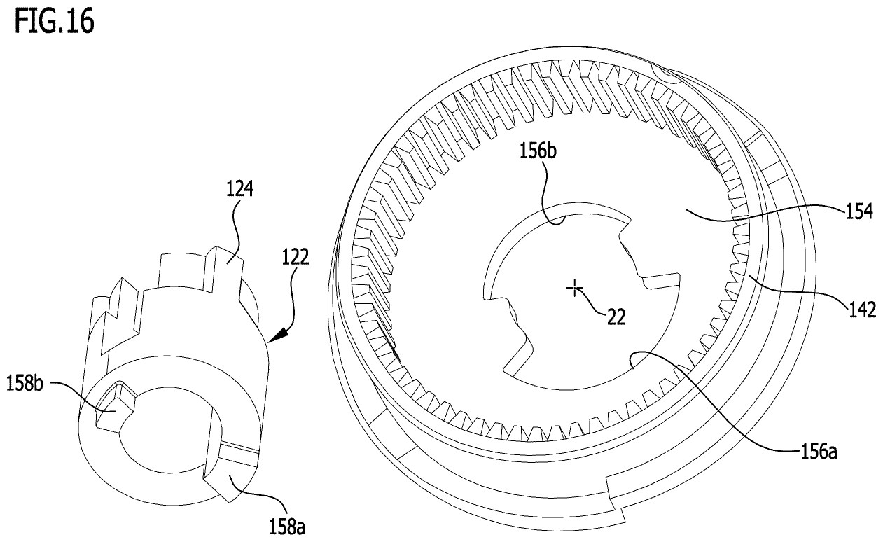

Furthermore, as shown in FIG. 16, the ring gear 142 comprises a flange body 154, which is located between the planet gear carrier 152 and the torsion spring 114 and which also extends in the direction of the pivot drive shaft 100, surrounds it, but is rotatable relative to it and represents an output of the planetary gearing 130 for actuating the rotation blocking device 50.

As shown in FIG. 16, the flange body 154 has circular arc-shaped drive slots 156a, 156b arranged circumferentially around the pivot axis 22, which interact with drive fingers 158a, 158b of the drive sleeve 122 engaging therein, and which are, however, formed in such a way, that the difference between the angular range around the pivot axis 22, over which the drive slots 156 extend, and the angular range around the pivot axis 22, over which the drive fingers 158 extend, enables the drive sleeve 122 to move freely relative to the ring gear 142, which will be explained in detail below.

Furthermore, the planet gears 146 are in engagement with their external toothing 148 with an external toothing 164 of a sun gear 162 of the planetary gearing 130, which is seated on a drive shaft designated as a whole as 166, which is arranged coaxially to the pivot axis 22 and is mounted freely rotatably, but coaxially to the pivot drive shaft 100, for example by means of an end shaft stub 168, which engages in an end-face bore 172 of the pivot drive shaft 100.

At a spacing from the planetary gearing 130, the drive shaft 166 carries a drive gear 174, for example a bevel gear, which is driven by an output gear of a motorized drive unit 182, which comprises, for example, on the one hand a drive motor, preferably an electric motor, and on the other hand a reduction gearing for driving the drive gear.

The drive unit 182 is held, for example, on a cover body 184 which, starting from the carrier plate 26, engages over the drive shaft 166 with the drive gear 174 and over the output gear meshing therewith and also supports the drive shaft 166 on a side facing away from the shaft stub 168.

Thus, the planetary gearing 130 and the drive unit 182 form, for example, inter alia, an actuating device 180 for the rotation blocking device 50.

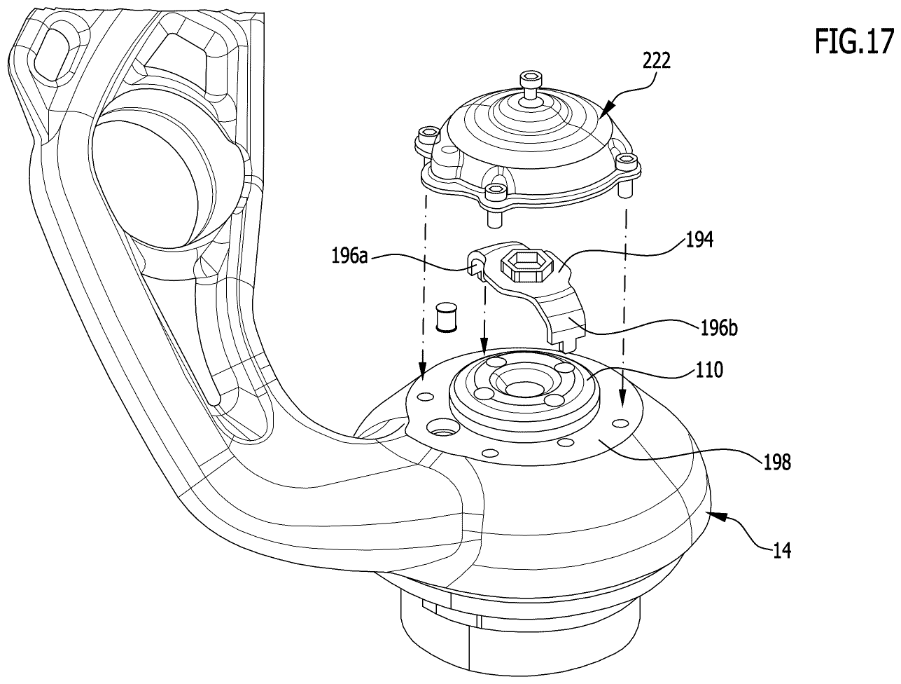

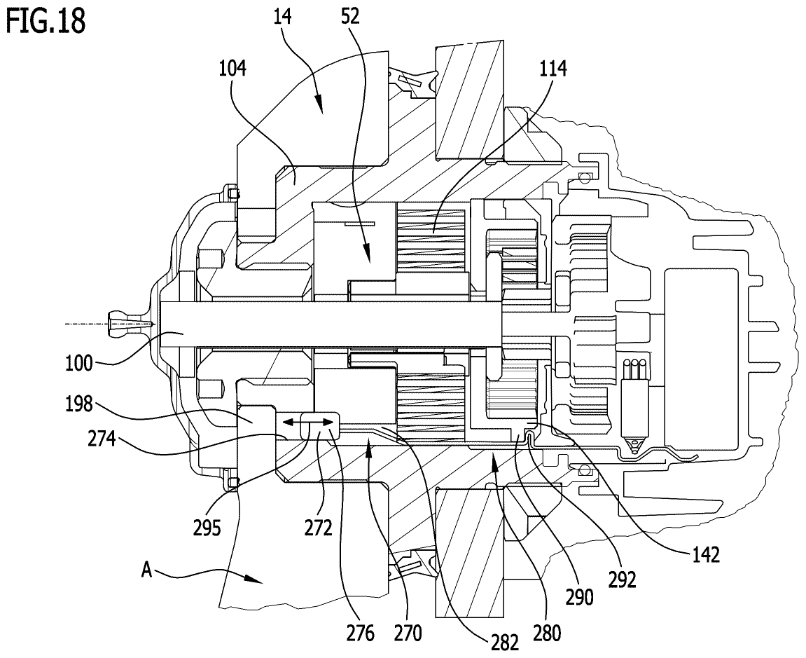

As already described, the pivot drive shaft 100, which is coupled to the planet gear carrier 152 for conjoint rotation, passes through the flange 104 of the guide body 40 and is coupled, for conjoint rotation, to a drive body 194 at an end 192 projecting beyond the insert 110 (FIGS. 17 and 18), which drive body has two drive arms 196a and 196b, which extend in the direction of an end flange 198 of the pivot bearing body 14, which engages over an external region 200 of the flange 104 of the guide body 40, and thereby positively engage in recesses thereof in order to produce a connection for conjoint rotation between the drive body 194 and the pivot bearing body 14.

The end flange 198 engages over the flange 104 of the guide body 40 in the outer region 200 and extends up to a guide projection 202 of the flange 104, wherein the end flange 198 engages, for example, with a radially inner cylindrical surface 204 around an outer cylindrical surface 206 of the guide projection 202 and, for example, abuts against the latter and is thereby also additionally guided on the guide projection 202 coaxially to the pivot axis 22.

In addition, there extends in the receptacle 106 of the guide projection 202 a thread 212, in which the insert 110 is fixed, in particular screwed in, which partially engages with an outer flange 214 over the end flange 198 in a radially inner region, so that the end flange 198 of the pivot bearing body 14 is guided axially non-displaceably between the flange 104 and the outer flange 214 of the insert 110 and thus axially non-displaceably relative to the guide body 40.

Furthermore, a cover 222 is non-rotatably mounted on the end flange 198 and engages over the drive body 194 with the drive arms 196 and forms a bearing receptacle 224 for the end 192 of the guide shaft 100, so that the cover 222 forms a unit with the pivot bearing body 14, which unit is rotatable about the pivot axis 22 (FIG. 17).

The cover 222 sits on the end flange 198 and is fixed to it non-rotatably.

In the solution described above, only one set of receptacles 60 is provided for the non-rotatable fixing of the pivot bearing body 14 in the working position A, while in the rest position R, fixing of the pivot bearing body 14 by the rotation blocking device 50 is not provided.

For safe operation of the trailer coupling according to the invention, a multiple blocking device designated as a whole by 270 is provided, which comprises a blocking body 272, which in turn is guided in a guide 274, for example formed as a bore in or on the flange 104 of the guide sleeve 44 of the guide body 40, which lies between the actuating body 52 and the end flange 198 of the pivot bearing body 14, in a displacement direction 295 for example in a direction parallel to the pivot axis 22.

As shown in FIG. 18, the blocking body 272 is configured to be positioned in such a way that, in a securing position, it is able, with a first end 276 facing the actuating body 52, to engage, starting from the guide 274, in a receptacle 282 of the actuating body 52 when the latter is in the rotation blocking position and thus fixes the pivot bearing body 14 with the ball neck 10 in the working position.

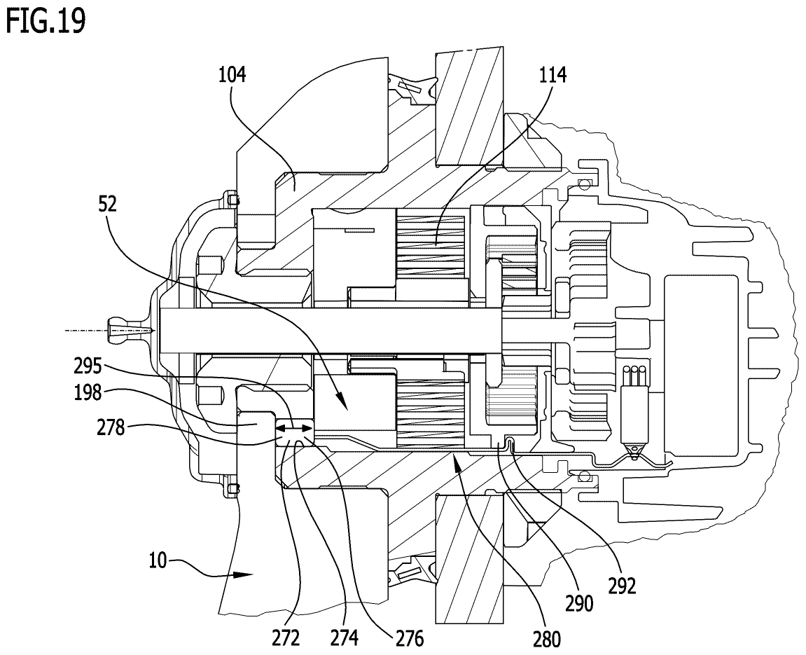

Furthermore, the blocking body 272, as shown in FIG. 19, is moveable into an intermediate position, in which it no longer engages with the first end 276 in the recess 282 of the actuating body 52, but is preferably positioned within the extent of the flange 104 in the displacement direction 295.

Furthermore, the blocking body 272 remains in the intermediate position with a second end 278 opposite the first end 276 without a blocking effect, and is preferably also positioned within the extent of the flange 104 in the displacement direction 295 (FIG. 19).

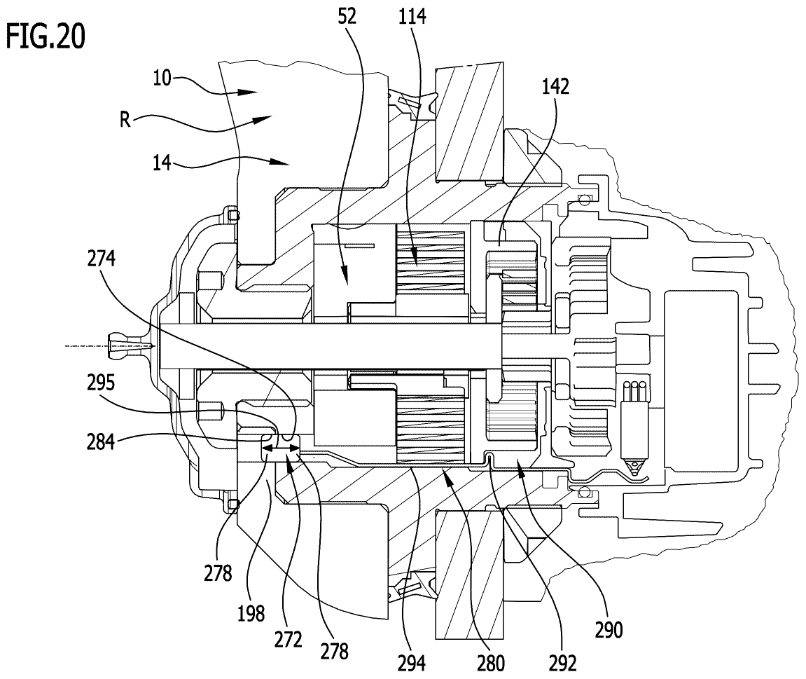

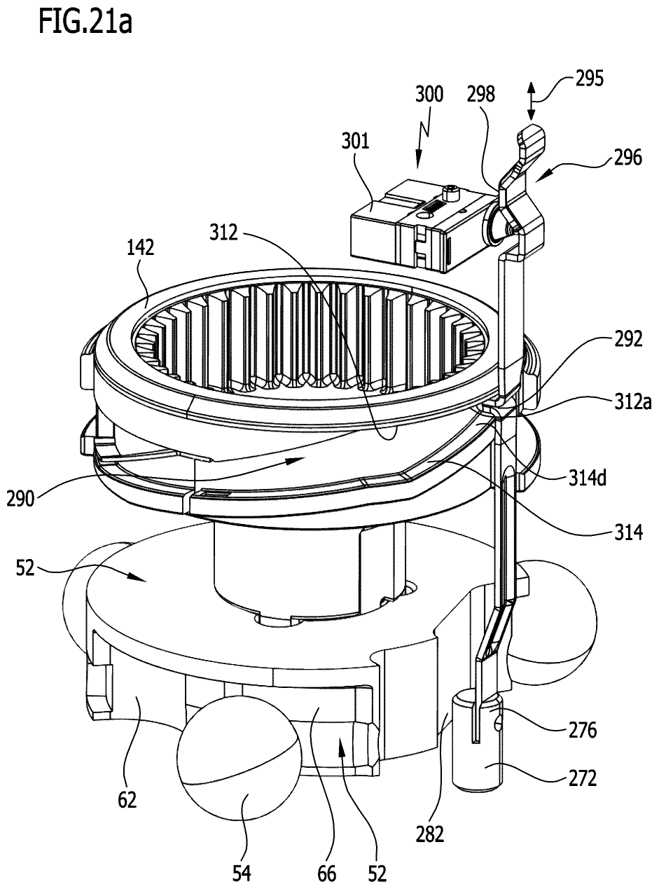

The blocking body 272 can also be displaced relative to the guide 274 in the displacement direction 295 in such a way that it engages with the second end 278 in a receptacle 284 of the end flange 198 of the pivot bearing body 14, and only when the pivot bearing body 14 and thus also the ball neck 10 are in the rest position (FIG. 20), so that the blocking body 272 is then in a rest position blocking position.

Thus, with the multiple blocking device 270, it is possible to secure the actuating body 52 in its rotation blocking position by moving the blocking body 272 in its displacement direction 295 in the securing position by means of the blocking body 272 and thus to enable an additional securing for the actuating body 52, which is already spring-loaded in the rotation blocking position, and, on the other hand, it is possible not to exert any blocking function in the intermediate position and to block the pivot bearing body 14 and thus also the ball neck 10 in the rest position in the rest position blocking position.

This movement of the blocking body 272 takes place by means of a blocking actuating device 280, which is coupled to the actuating unit 180 for the rotation blocking device 50.

The blocking actuating device 280 comprises a camming guide designated as a whole by 290, wherein the camming guide 290 acts on a cam follower 292, which in turn acts on a transmission element 294 of the blocking actuating device 280 coupled to the blocking body 272 and likewise movable in the displacement direction 295, so that the blocking body 272 can be moved by the blocking actuating device 280 into the securing position, the intermediate position and the rest position blocking position.

Preferably, the camming guide 290 is arranged on the circumferential side of the ring gear 142 of the actuating unit 180, which is part of the planetary gearing 130, which on the one hand serves to drive the actuating body 52 of the rotation blocking device 50 by means of the drive sleeve 122 and on the other hand serves to pivot the pivot bearing body 14 by driving the pivot drive shaft 100 by means of the planet gear carrier 152 coupled thereto.

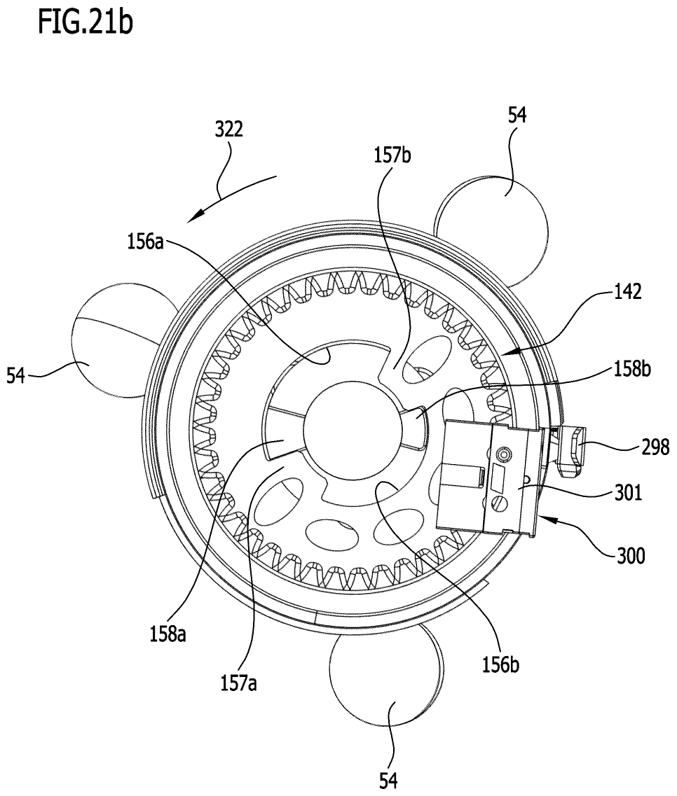

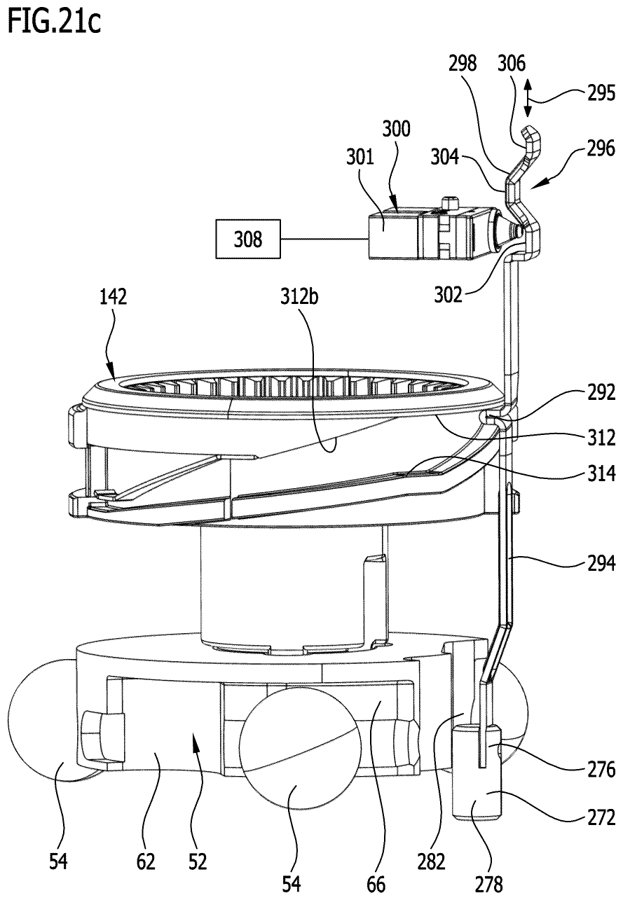

As shown in FIG. 21, in particular FIG. 21a, the actuating body 52 is positioned in the rotation blocking position of the rotation blocking device 50 in such a way that it acts on the rotation blocking bodies 54 in the radial direction relative to the pivot axis 22 and moves them in the guide direction 58 into the receptacles 60 provided, in order thus to fix the pivot bearing body 14 non-rotatably relative to the pivot axis 22 in the working position A.

For this purpose, the pushing surfaces 66 of the actuating body 52 act in particular on the rotation blocking bodies 54, as shown likewise in FIG. 21a.

For example, the recess 282, in which the blocking body 272 engages with its first end 276 to secure the rotation position of the actuating body 52, lies here next to the retraction receptacle 62 and a pushing surface 66 of a rotation blocking body 54 following next in the circumferential direction.

As further shown in FIG. 21a, the camming guide 290 comprises camming paths 312 and 314 which are arranged facing each other on the circumferential side of the ring gear 142 and which, for positioning the cam follower 292 in the securing position of the blocking body 272, run with positioning portions 312a and 314e relative to each other in such a way that the cam follower 292 is positioned exactly between these positioning portions 312a and 314e of the two camming paths 312 and 314 in the securing position and thus in a defined manner and has no possibility whatsoever to move in its displacement direction 295, for example in a direction parallel to the pivot axis 22, into the intermediate position or the rest position blocking position, so that by this precisely defined positioning of the cam follower 292 the transmission element 294 positions the blocking body 272 non-displaceably in the securing position and thus additionally secures the actuating body 52.

Furthermore, as shown in FIG. 21c, the transmission element 294 extends to a sensor actuating element 296 which, in a first exemplary embodiment of a sensor unit 300 comprising an evaluation unit 308 and a sensor 301, actuates the sensor 301 when the transmission element 294 is moved in the displacement direction 295 by means of a mechanical position indicating element 298 movable relative to the sensor 301.

In particular, in the illustrated case of a sensor 301 formed as a push-button, the position indicating element 298 has a first sensing surface 302, a second sensing surface 304 rising toward the sensor 301 transversely to the displacement direction 295′with respect to the first sensing surface 302, and a third sensing surface 306 configured and running in accordance with the first sensing surface, so that the first sensing surface 302 and the third sensing surface 306 generate the same first signal in cooperation with the sensor 301, while the second sensing surface 304, due to the fact that it is raised relative to the first 302 and third sensing surface 306, generates a second signal which differs from the first signal.

For example, the first sensing surface 302 serves to detect the securing position, the second sensing surface 304 serves to detect the intermediate position and the third sensing surface 306 serves to detect the rest position blocking position, wherein in the simplest case the first sensing surface 302 running relative to the displacement direction 295 and the third sensing surface 306 generate the same first sensing signal of the sensor 301, while the second sensing surface 304 rising relative to the displacement direction 295 generates a different second sensing signal of the sensor 301.

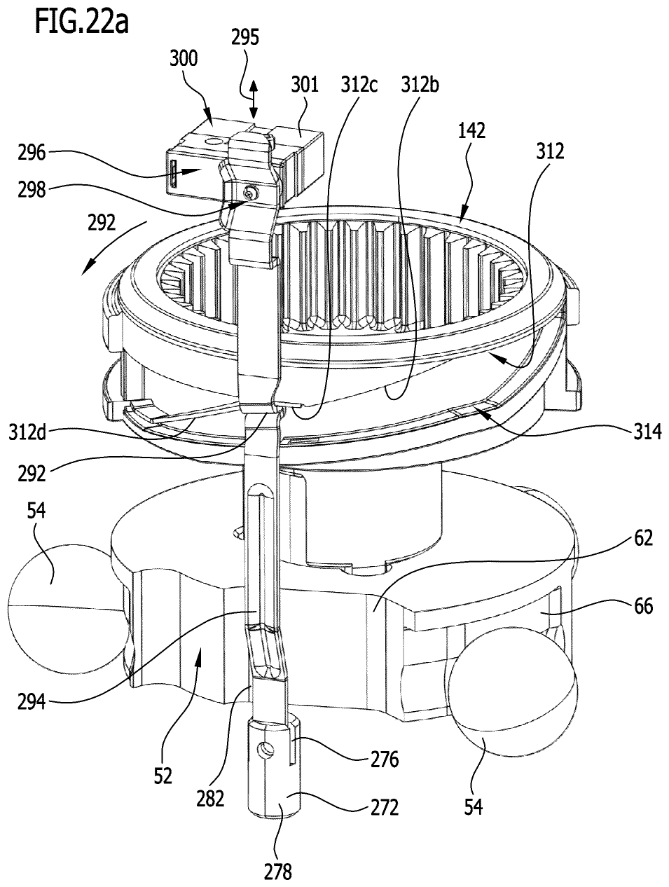

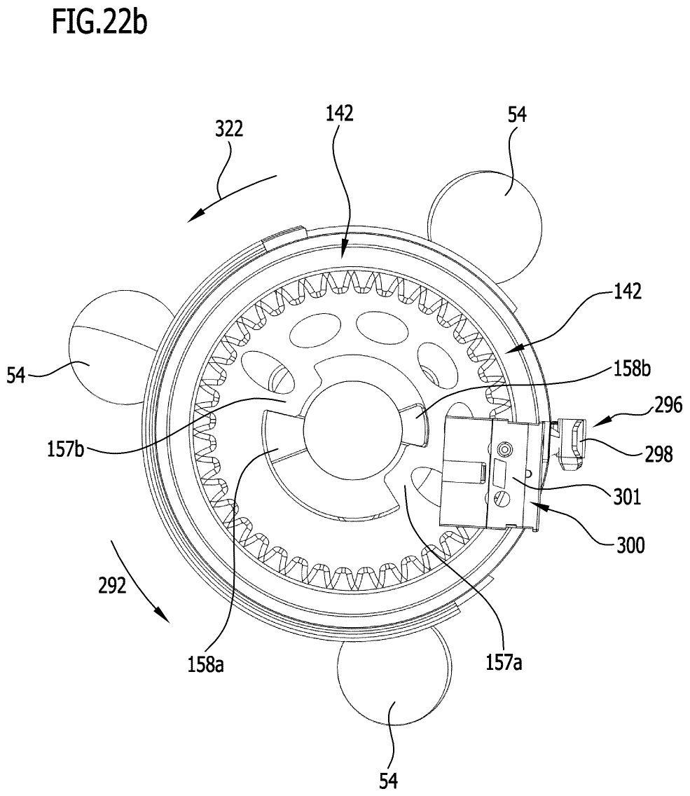

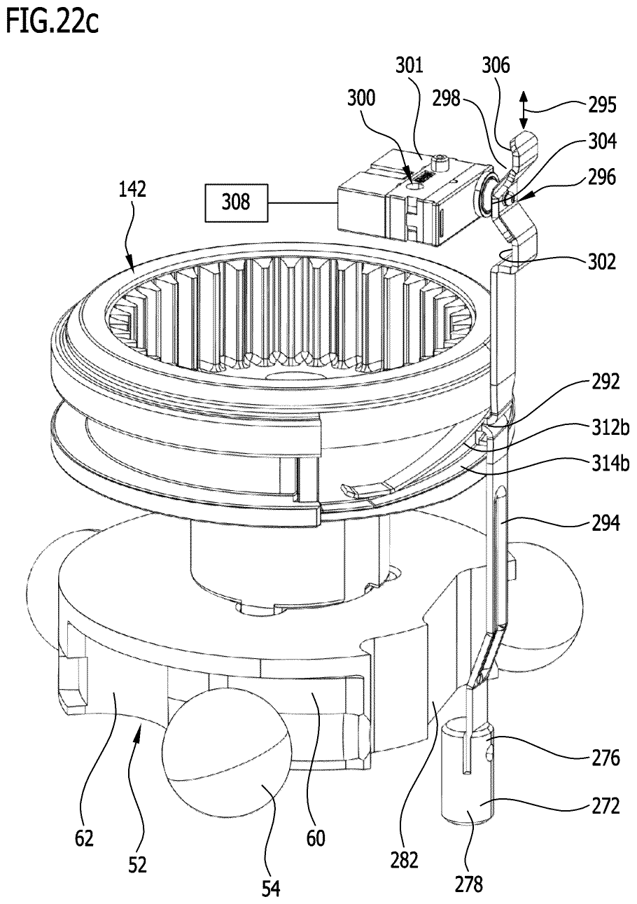

As also shown in FIG. 21b, in the starting position of the ring gear 142 of the planetary gearing 130, the drive fingers 158a and 158b engaging in the drive slots 156a and 156b are in contact with the drive webs 157a and 157b separating the drive slots 156a and 156b, in such a way that driving of the ring gear 142 initially does not cause the drive fingers 158a and 158b to be driven, since the ring gear 142 moves in the rotational direction 322 in which the drive webs 157a and 157b move away from the drive fingers 158a and 158b, as shown in FIG. 22b.

This causes the cam follower 292 to move along an ejection portion 312b of the camming path 312 (FIG. 22a), which displaces the cam follower 292 and the transmission element 294 such that the blocking body 272 moves out of the recess 282 in the actuating body 52 into the intermediate position, in which, as shown in FIG. 19, the blocking body neither engages with the first end 276 in the recess 282 in the actuating body 52 nor engages with the second end 278 in the recess 284 in the flange 198 of the pivot bearing body 14.

In this intermediate position, defined by the positioning portion 312c, the actuating body 52 is not secured against further rotation.

After reaching the end of the ejection portion 312a and the thus achieved cancellation of the securing position, a further rotation of the ring gear 142, as shown in FIG. 22b, causes the drive webs 157a and 157b to act on the drive fingers 158b and 158a, respectively, and these can continue to rotate in the rotational direction 322.

A further consequence of reaching the intermediate position is that the displacement of the transmission element 294 to move the blocking body 272 simultaneously causes a displacement of the sensor actuating element 296, with the result that the latter acts on the sensor 300 with the second sensing surface 304 and the sensor is thus able to detect the intermediate position, as shown in FIG. 22c.

A further rotation of the ring gear 142 in the rotational direction 322 results in the drive webs 157a and 157b acting on the drive fingers 158a and 158b, respectively, and thus leading to a cancellation of the rotation blocking position, so that the rotation blocking bodies 54 can enter into the retraction receptacles 62 of the actuating body 52 and are thus no longer acted upon in the radial direction by the pushing surfaces 66.

This cancels the rotation blocking position of the rotation blocking device 50.

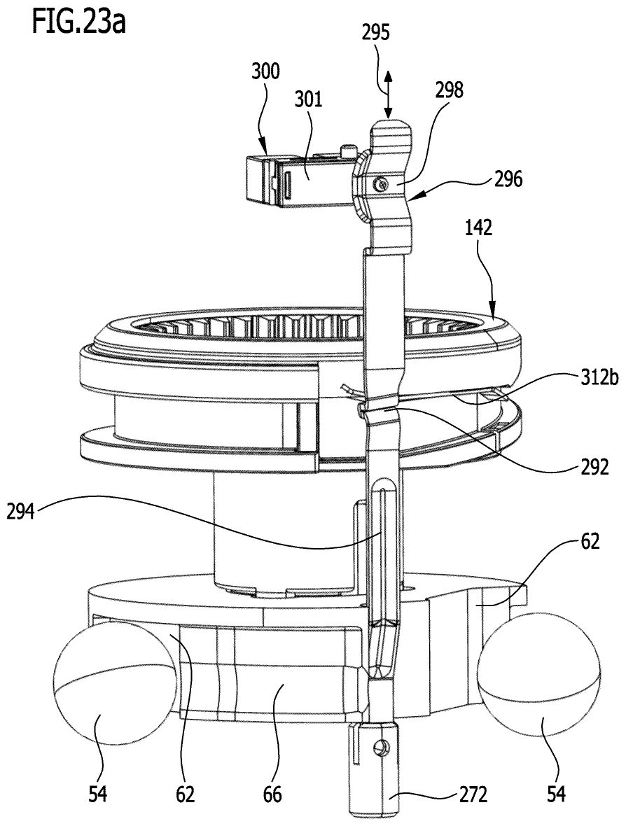

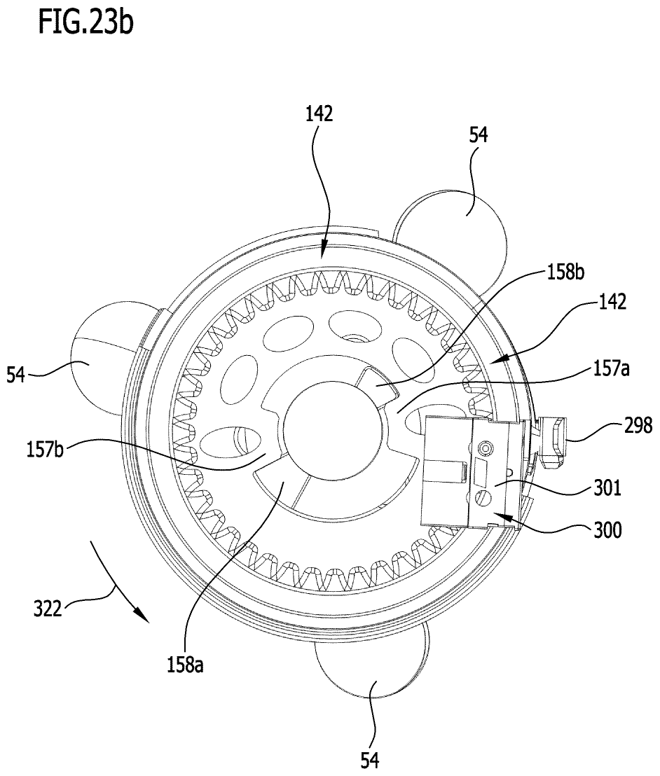

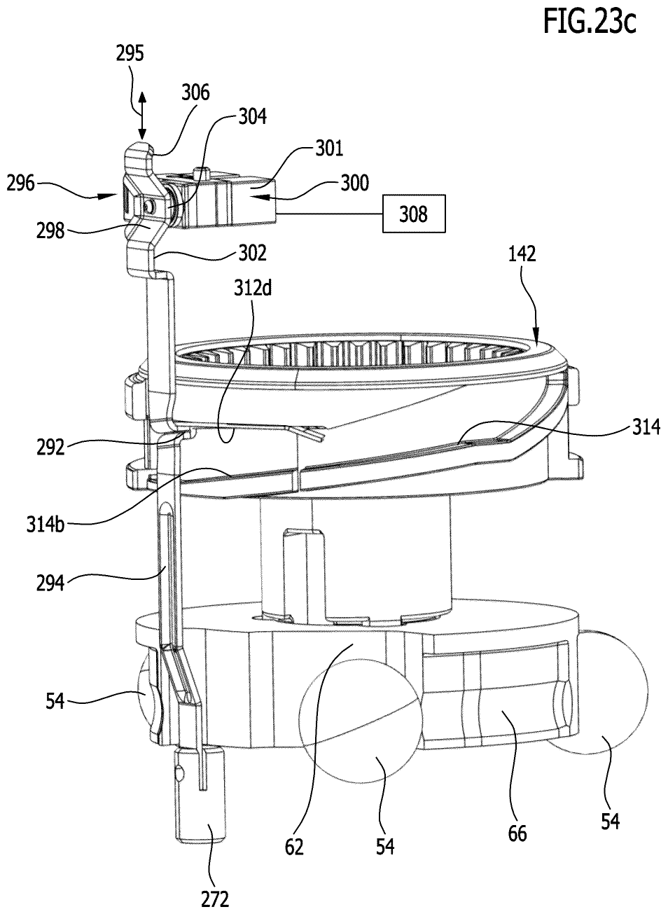

Due to this further rotation of the ring gear 142, the cam follower 292 also follows a loading portion 312d of the camming path 312 in the form of a resilient element, for example a leaf spring, which, however, as can be seen from the comparison of FIG. 23a with FIG. 22a, initially leads to an elastic loading of the cam follower 292, so that the latter, as can be seen in FIGS. 23a and 23c, initially allows the blocking body 272 to remain in the intermediate position due to the blocking of the movement of the blocking body 272 by the end flange 198 of the pivot bearing body 14m, as shown in FIG. 19.

The possibility of the loading portion 312b to initially load the cam follower 292 with an elastically acting spring force without displacing the blocking body 272 is required by the fact that although the rotation blocking position of the rotation blocking device 50 is released, the pivot bearing body 14 has not yet been rotated, and thus the end flange 198 does not allow the blocking body 272 to be displaced into the rest position blocking position.

Such rotation of the pivot bearing body 14 occurs due to the fact that the rotation position shown in FIG. 23b moves the actuating body 52 into its release position against the force of the torsion spring 114, but it remains in the release position and therefore cannot be rotated any further.

This means that the drive fingers 158a and 158b block further rotation of the ring gear 142 by acting on the drive webs 157b and 157a and thus enable the planet gear carrier 152 to be driven due to a blocking of the rotation movement of the ring gear 142 in the rotational direction 292 when the planetary gearing 130 is driven further, which leads to a pivoting of the pivot bearing body 14 and thus of the ball neck 10.

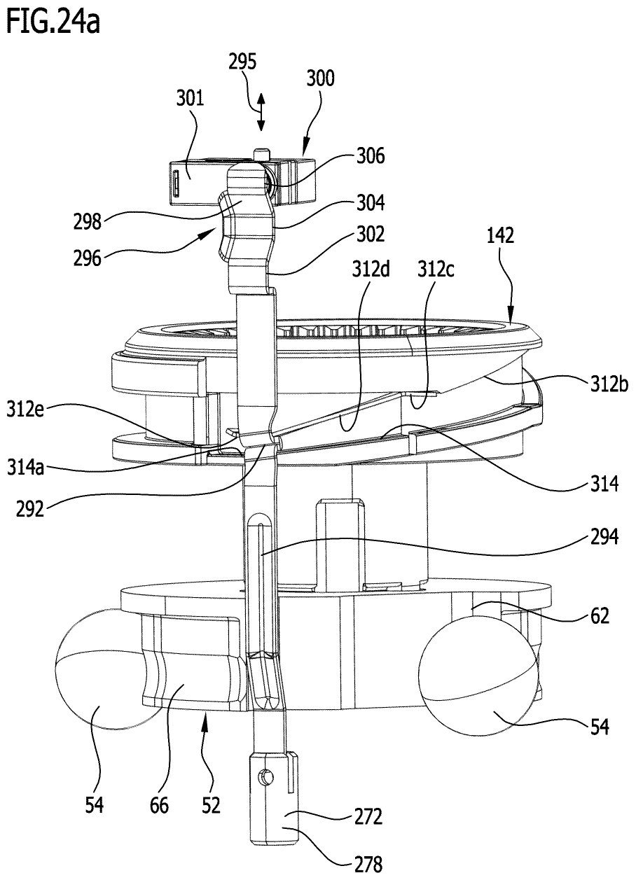

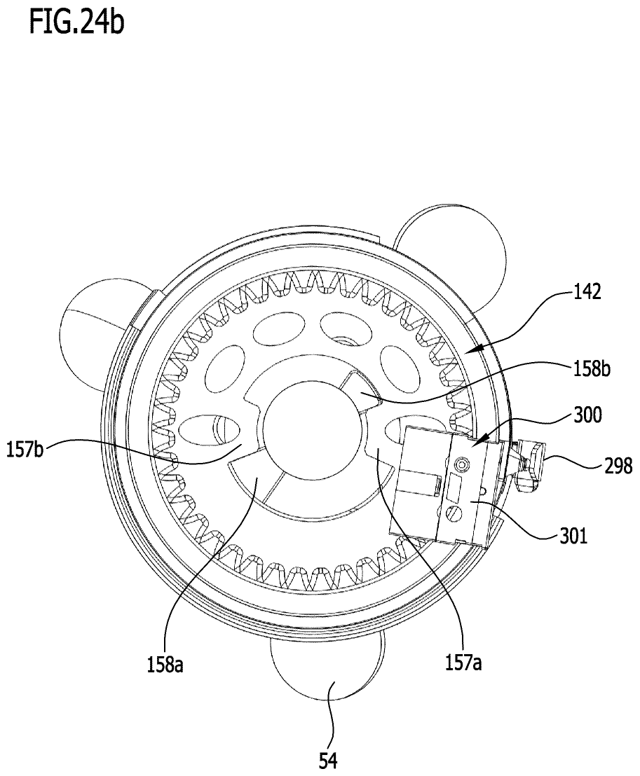

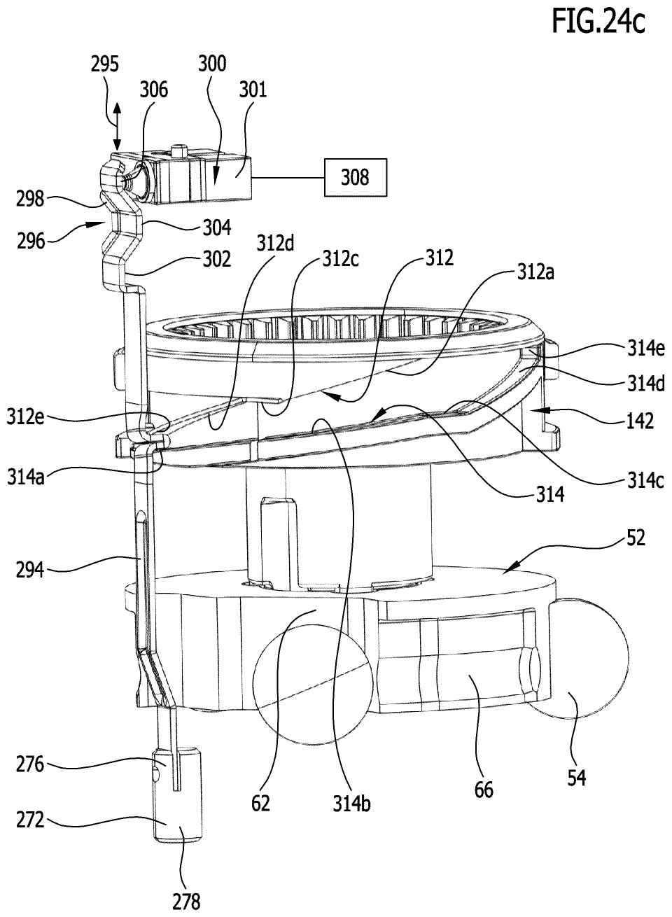

This pivoting of the pivot bearing body 14 causes its end flange 198 to rotate relative to the flange 104 until the ball neck 10 reaches the rest position, in which the receptacle 284 in the end flange 198 is arranged in alignment with the guide 274, so that the blocking body 272 can then enter the receptacle 284 with the end 278, as shown in FIG. 20 and FIG. 24c.

At the moment of alignment of the receptacle 284 with the guide 274 of the blocking body 272, the elastically acting loading portion 312d of the camming path 312 can displace the cam follower 292 in the direction of the camming path 314 and thus push the actuating body 272 with the second end 278 into the receptacle 284 by means of the transmission element 294.

In this position, the rotation blocking bodies 54 are still in their release position lying in the retraction receptacles 62, since these have no possibility of entering receptacles 60 in the pivot bearing body 14 opposite them despite being acted upon by means of the torsion spring 114, as can be seen from FIG. 14.

In the rest position blocking position now reached, shown in FIG. 20 and FIG. 24, the elastic loading portion 312d with the positioning portion 312e presses the cam follower 292 so far in the direction of the camming path 314 that the cam follower 292 is positioned in a defined manner between a positioning portion 314a of the camming path 314 and the elastic positioning portion 312e and thus the rest position blocking position is maintained in a defined manner.

In this case too, as shown in FIG. 24c, the transmission element 294 is used to displace the position indicating element 298 relative to the sensor 300 to such an extent that the sensing surface 306 acts on the sensor and the sensor is in turn able to detect the rest position blocking position.

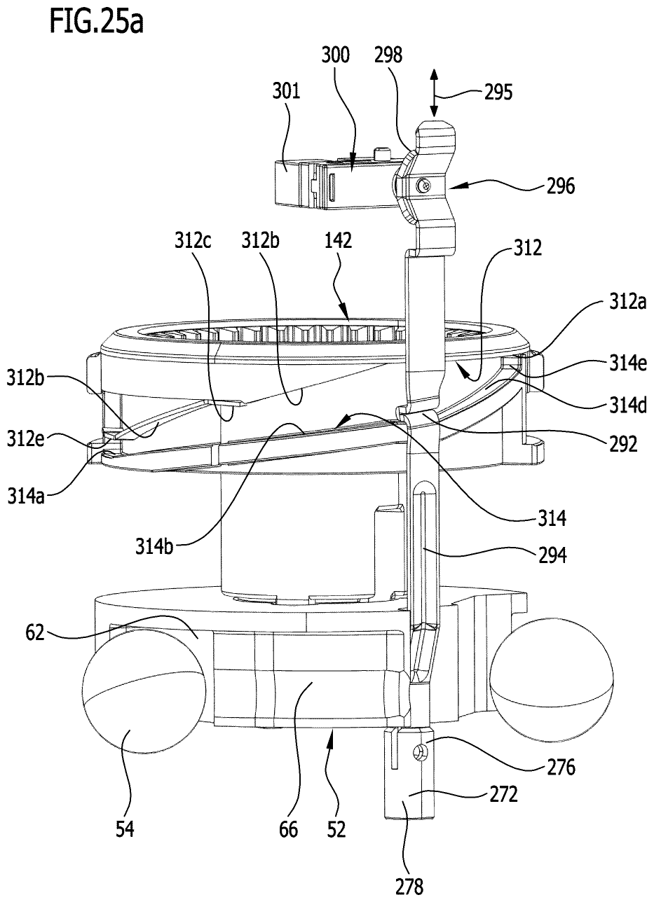

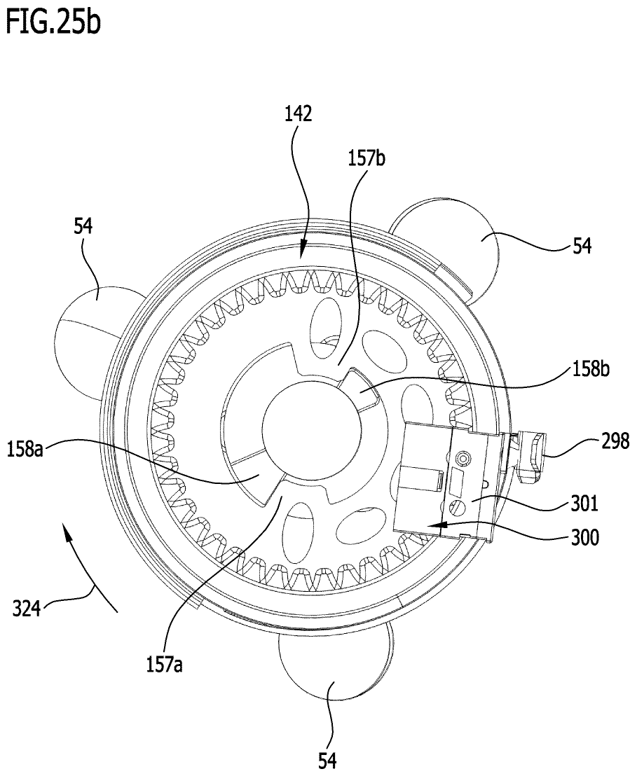

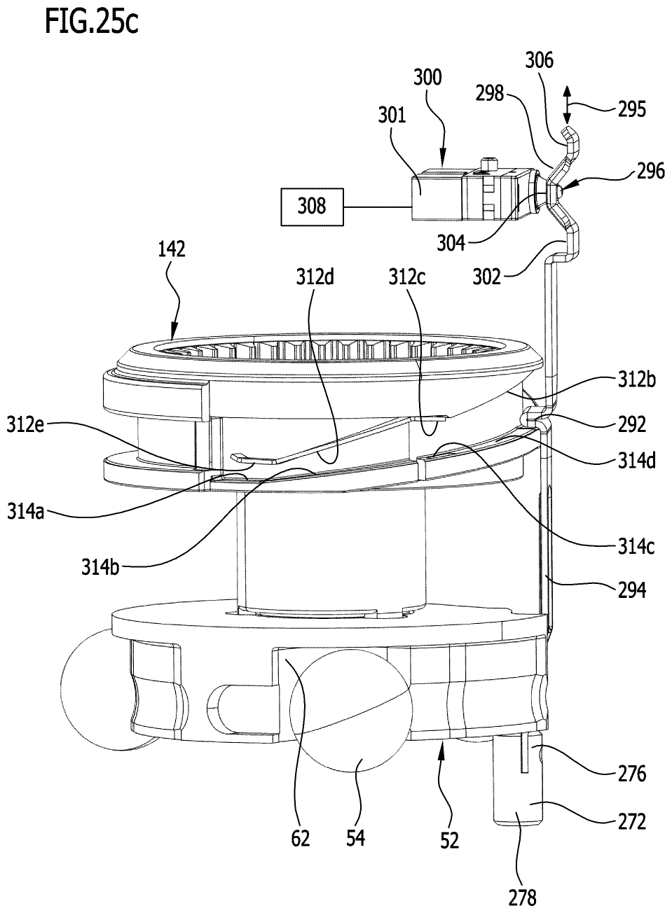

In order to be able to pivot the ball neck 10 with the pivot bearing element 14 back from the rest position R to the working position A, the drive direction must be reversed so that, as shown in FIG. 25b, the ring gear 142 is now rotated in the opposite direction to the rotational direction 322, i.e. in the rotational direction 324, as a result of which the drive fingers 158a and 158b are not initially acted upon, but the drive webs 157a and 157b can be rotated independently of the drive fingers 158a and 158b until the drive webs 157a and 157b are again in contact with the drive fingers 158a and 158b, as shown in FIG. 25b.

As shown in FIG. 25a, this has the consequence that now, starting from the rest position blocking position, the cam follower 292 can be acted upon by the camming path 314, in particular the ejection portion 314b, and thus the cam follower 292 moves again in the direction of the camming path 312, so that the blocking body 272, starting from the rest position blocking position, is moved again into the intermediate position, shown in FIG. 25a.

In order to reach this intermediate position, the ejection portion 314b extends as far as a positioning portion 314c in the direction of the camming path 312 so that a position is reached with the cam follower 292 which corresponds approximately to the positioning portion 312c at the end of the ejection portion 312b and thus the intermediate position of the blocking body 272 is identical to the intermediate position in the positioning portion 312c after passing through the ejection portion 312b.

During this rotation movement of the ring gear 142, there is no rotation movement of the actuating body 52, so that the rotation blocking bodies 54 still remain in the retraction receptacles 62 and thus in the release position.

However, as shown in FIG. 25b, the displacement of the cam follower 292 results in a displacement of the position indicating element 298, so that the second sensing surface 304 now acts on the sensor 300, which in turn detects the intermediate position.

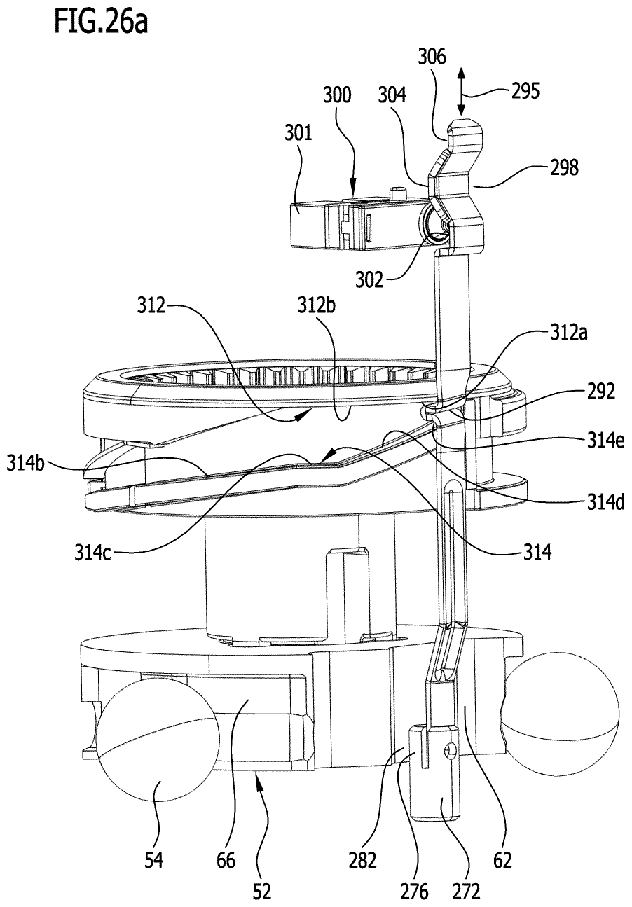

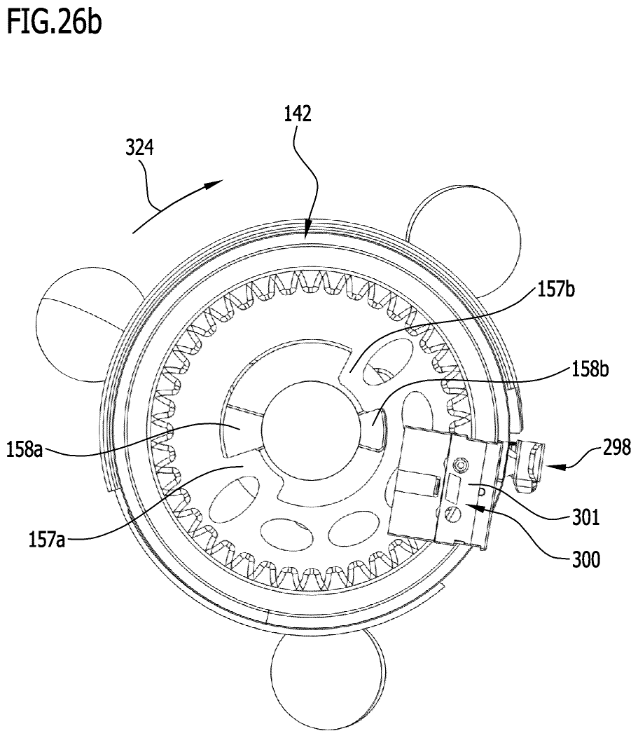

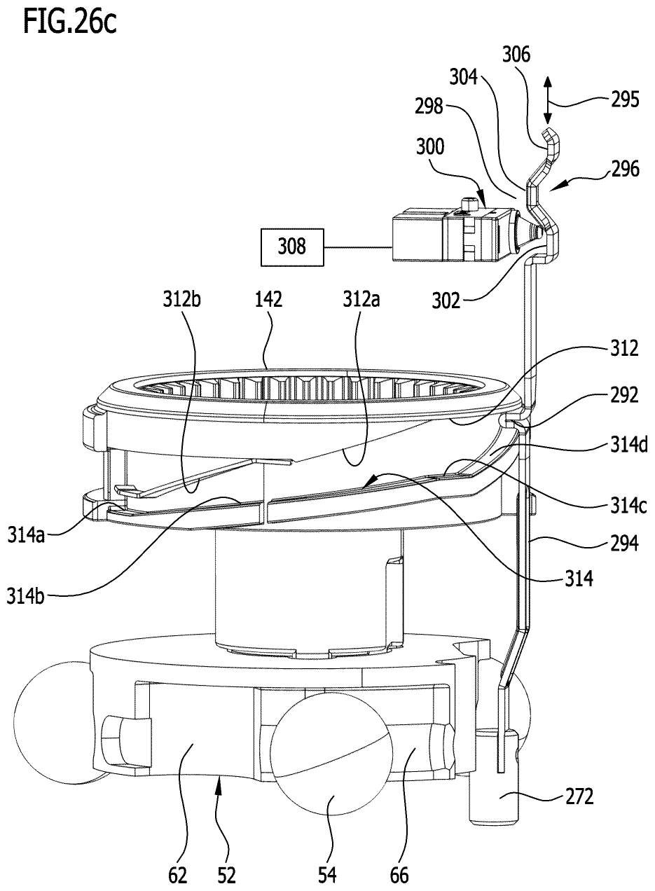

Further rotation of the ring gear 142 is not possible in this intermediate position, since the actuating body 52 still remains in its release position and thus the drive fingers 156 and 158 prevent further rotation of the ring gear 142 until the pivot bearing body 14 with the ball neck 10, driven by the planet gear carrier 152 have reached the working position A, in which the rotation blocking device 50 has the possibility to transfer to the rotation blocking position and thus the drive fingers 158a and 158b again allow rotation of the ring gear 142, so that then, as shown in FIG. 26a, the loading portion 314d can act on the cam follower 292 and move it into the position corresponding to the securing position of the blocking body 272, which is predetermined by the positioning portions 314e and 312a and in which the first end 276 of the blocking body 272 enters into the receptacle 282 (FIG. 26a).

At the same time, in this securing position, the cam follower 292 is positioned in a defined manner between the camming paths 312 and 314.

In the rotation blocking position, the rotation blocking bodies 54 are then in turn also acted upon by the pushing surfaces 56, so that the receptacle 282 is in turn also aligned with the guide 274 for the blocking body 272 and this also enables the blocking body 272 to be displaced into the securing position (FIG. 26c).

Similarly, the transmission element 294 displaces the position indicating element 298 into the position corresponding to the securing position, in which the first sensing surface 302 again acts on the sensor 301 (FIG. 26c).

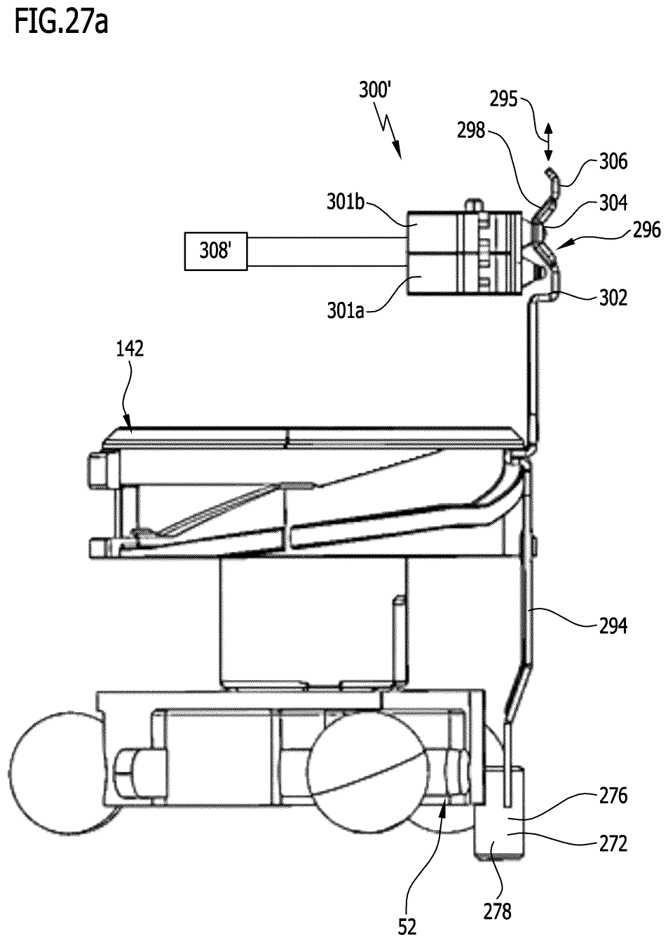

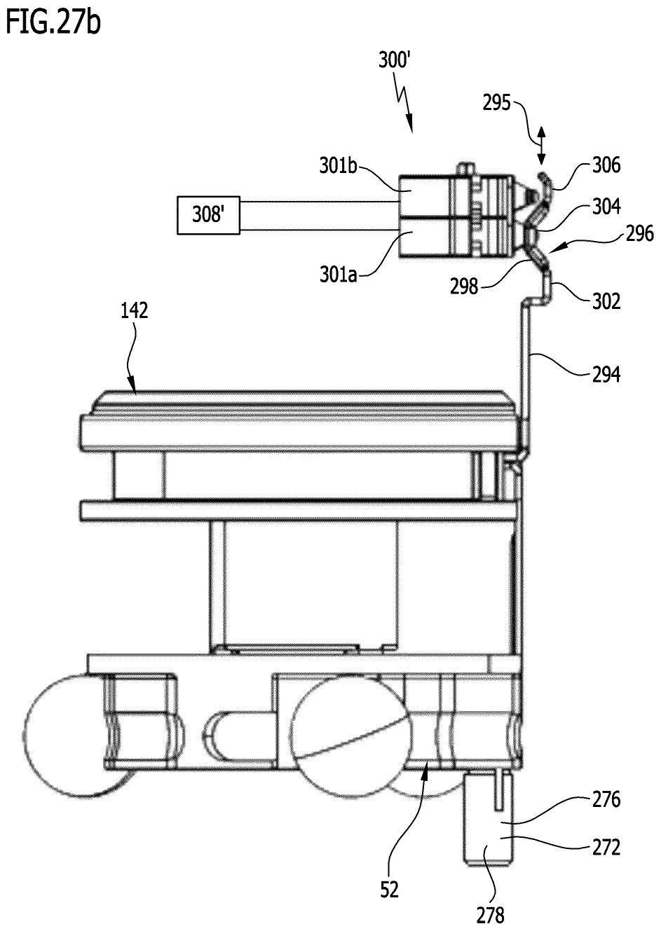

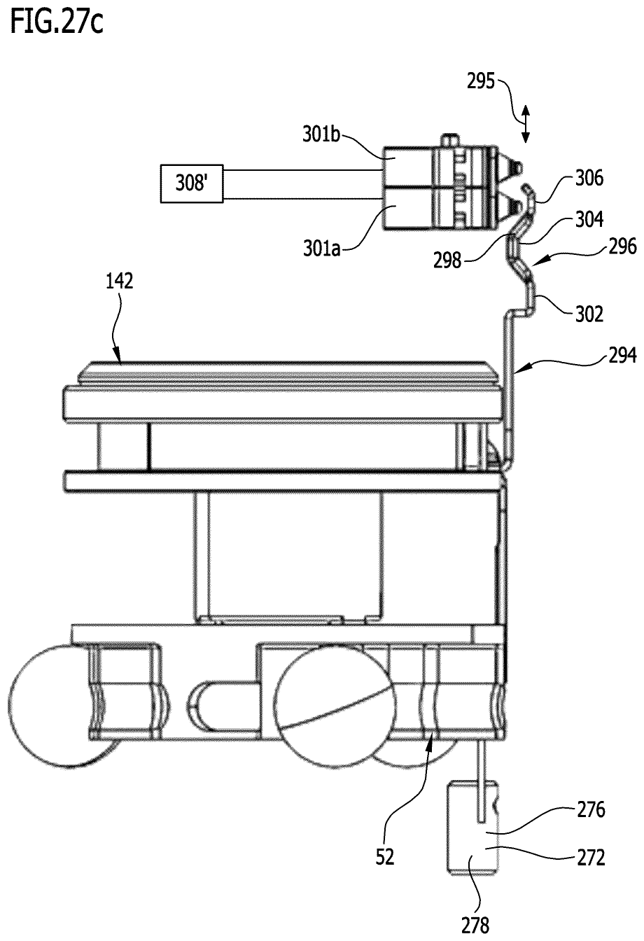

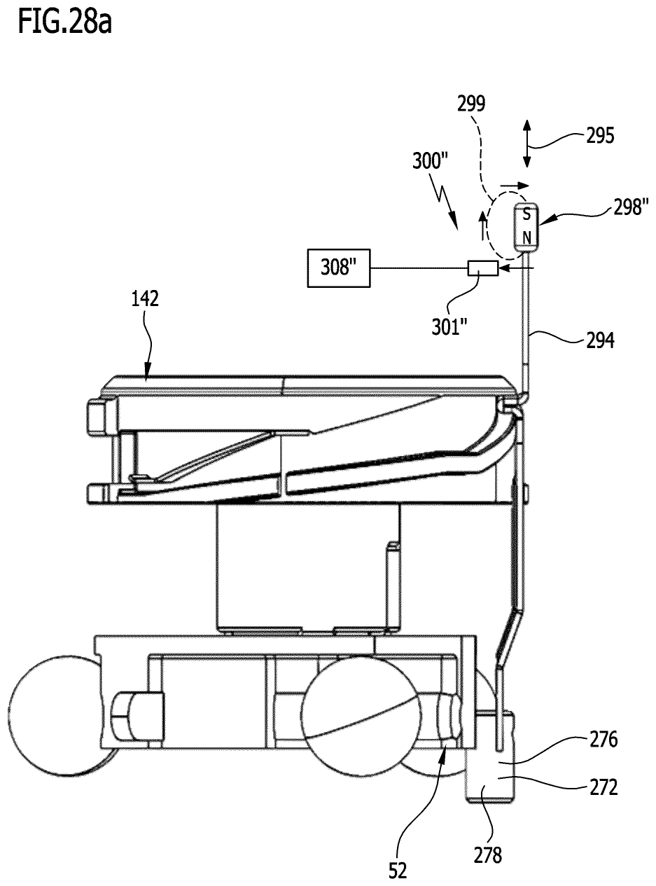

In a second exemplary embodiment of a sensor unit 300′according to the invention, shown in FIGS. 27a, 27b and 27c, the position indicating element 298 is formed in the same way as described in conjunction with the first exemplary embodiment, i.e., the first sensing surface 302 and the third sensing surface 306 generate the same signal in the case of a sensor 301 formed as a push-button, while the second sensing surface 304 generates a signal of the sensor formed as a push-button that differs therefrom.

For this reason, in the second exemplary embodiment, two sensors 301a and 301b are provided in the form of push-buttons, which are arranged next to each other such that each of the sensors 301a and 301b can respectively scan one of the sensing surfaces 302, 304 and 306 of two respective adjacent sensing surfaces 302 and 304 or 304 and 306.

As shown in FIG. 27a, in the securing position of the blocking body 272, the position indicating element 298 is positioned by the transmission element 294 such that the first sensor 301a scans the first sensing face 302 and the second sensor 301b scans the second sensing surface 304.

As a result, the first sensor 301a generates a first signal that corresponds to one of the sensing surfaces 302 or 306, while the second sensor 301b generates a second signal that corresponds to the second sensing surface 304.

When the blocking body 272 is moved from the securing position shown in FIG. 27a to the intermediate position shown in FIG. 27b, the transmission element 294 displaces the position indicating element 298 to such an extent that the first sensor 301a scans the second sensing face 304 and that this generates a corresponding second signal, while the second sensor 301b scans the third sensing surface 306 and generates the first signal, which is different from that of the second sensing surface 304.

Thus, the sensors 301a and 301b generate exactly the opposite signals in the intermediate position as in the securing position according to FIG. 27a.

If the blocking body 272 is moved to the rest position blocking position, as shown in FIG. 27c, the first sensor 301a scans the third sensing surface 306 and the second sensor 301b does not scan any sensing surface and thus generates the same first signal as the first sensor that scans the third sensing surface 306.

This means that in this case, both sensors 301 and 301b generate the same first signal.

Thus, the securing position according to FIG. 27a, the intermediate position according to FIG. 27b and the rest position blocking position according to FIG. 27c can be clearly distinguished and displayed in a simple manner when evaluating the sensing signals of the sensors 301a and 301b in relation to each other by means of an evaluation unit 308′.

This means that the securing position, the intermediate position and the rest position blocking position can be clearly identified for an evaluation unit 308′and communicated at an output.

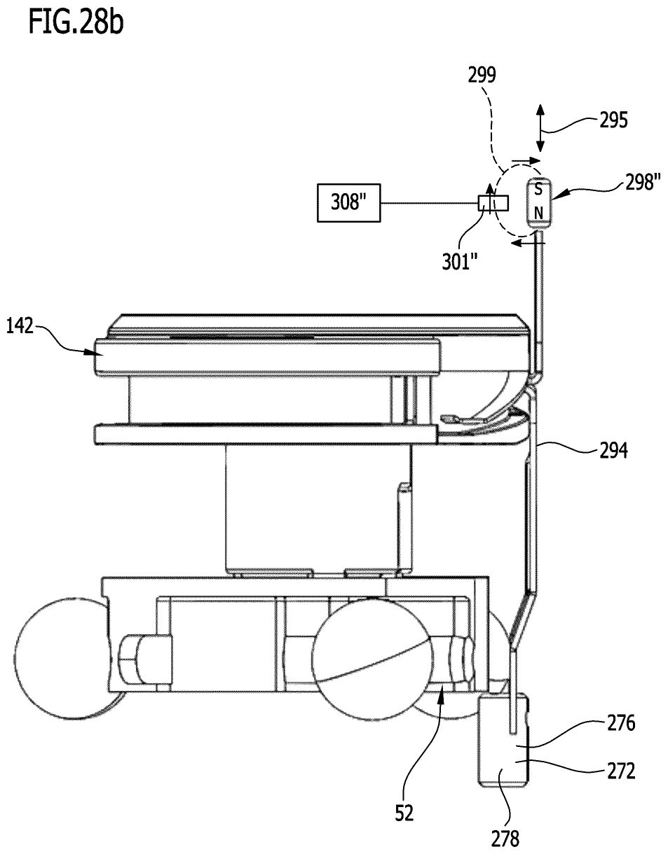

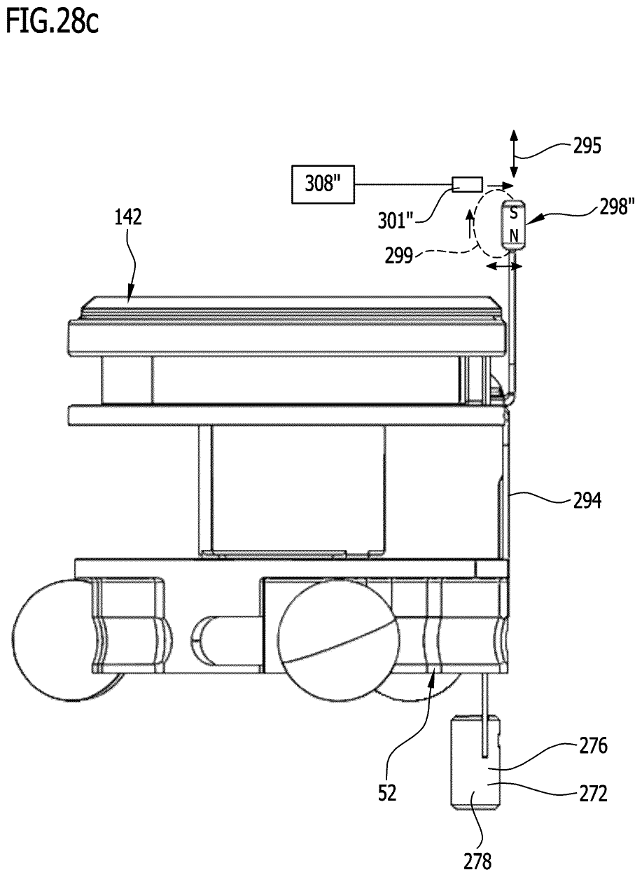

In a third exemplary embodiment of a sensor unit 300″ according to the invention, shown in FIGS. 28a, 28b and 28c, the sensor 301″ is formed as a magnetic field sensor that is able to detect different magnetic field directions in space.

Furthermore, the position indicating element 298″ is formed as a magnet of which the north pole N and south pole S are spaced apart in the displacement direction 295 of the transmission element 294 and generate a magnetic field 299 running in space around the outside of the position indicating element 298″, which is formed as a magnet, which in the region near the north pole runs transversely in a first direction in space running transversely to the displacement direction, in the region between the north pole and south pole runs approximately parallel to the displacement direction 295 in space, and in the region near the south pole runs in a second direction in space opposite to the first direction.

Thus, the magnetic field sensor 301″ can recognize different positions of the position indicating element 298″ formed as a magnet.

For example, in the securing position of the blocking body 272, the magnetic field sensor 301″ recognizes the partial region of the magnetic field 299 running in the first direction transverse to the displacement direction, for example in the direction of the magnetic field sensor 301′in space.

If the blocking body 272 is displaced into the intermediate position, as shown in FIG. 28b, the magnetic field sensor 301″ is penetrated by the partial region of the magnetic field between the north pole N and the south pole S that runs parallel to the displacement direction 295 and thus detects a direction of the magnetic field in space that has changed by 90° relative to the direction in the securing position.

If, on the other hand, the blocking body 272 is displaced into the rest position blocking position, the magnetic field sensor 301″ detects, as shown in FIG. 28c, the partial region of the magnetic field 299 close to the south pole S in space that is directed transversely to the displacement direction 295, but away from the magnetic field sensor 301″.

This enables an evaluation unit 308″ to clearly distinguish and communicate the securing position, the intermediate position and the rest position blocking position by recognizing the different directions of the magnetic field 299 in space by means of the magnetic field sensor 301″.

1. A trailer coupling, comprising a ball neck which is moveable between a working position and a rest position, is connected at a first end to a pivot bearing unit and carries a coupling ball at a second end, the ball neck being pivotable about a pivot axis between the working position and the rest position by way of the pivot bearing unit when a pivoting movement is carried out, and a rotation blocking device acting between a guide body and a pivot bearing body of the pivot bearing unit, having on the one hand at least two rotation blocking units, each of which has a rotation blocking body which is guided movably in a guide direction by way of a guide receptacle of the guide body and which is movable in the guide direction by a pushing surface extending transversely to the guide direction and provided on an actuating body, and having on the other hand at least two receptacles, wherein the rotation blocking bodies of all rotation blocking units are configured to be moved and acted upon in the guide direction by a movement of the actuating body in an actuating direction and wherein the rotation blocking bodies of all rotation blocking units are configured to be brought into a rotation blocking position in the working position by a movement in the guide direction and in this position each rotation blocking body comes into engagement with one of the receptacles in each case in order to block a pivoting movement of the pivot bearing body and of the guide body relative to one another about the pivot axis, and is configured to be brought into a release position, and in this position is disengaged from the respective receptacle and releases the relative movement between the pivot bearing body and the guide body, wherein in all intended relative pivot positions between the pivot bearing body and the guide body, including the rest position and excluding the working position, a movement of the actuating body in the actuating direction and consequently also a force-loaded engagement of the rotation blocking bodies of each of the rotation blocking units into one of the receptacles in each case is blocked, wherein a multiple blocking device is provided, which comprises a blocking body which is configured to be moved into a rest position blocking position blocking the pivot bearing body and the guide body relative to each other in the rest position, into a securing position securing the actuating body in the rotation blocking position, and into an intermediate position lying between the rest position blocking position and the securing position.

2. The trailer coupling in accordance with claim 1, wherein the blocking body is guided on the guide body of the pivot bearing unit.

3. The trailer coupling in accordance with claim 1, wherein the blocking body is guided in a guide arranged on the guide body.

4. The trailer coupling in accordance with claim 1, wherein the guide for the blocking body is arranged in a wall region of the guide body adjacent to the actuating body and the pivot bearing body.

5. The trailer coupling in accordance with claim 3, wherein the blocking body is movable in the guide in a direction approximately parallel to the pivot axis.

6. The trailer coupling in accordance with claim 1, wherein the blocking body in the rest position blocking position engages in a receptacle in the pivot bearing body.

7. The trailer coupling in accordance with claim 1, wherein the blocking body in the securing position engages into a receptacle in the actuating body.

8. The trailer coupling in accordance with claim 1, wherein the blocking body is arranged in the intermediate position between the receptacle in the actuating body and the receptacle in the pivot bearing unit.

9. The trailer coupling in accordance with claim 3, wherein the blocking body, starting both in the securing position and in the rest position blocking position and guided by the guide, engages in each case with one end in the respective receptacle.

10. The trailer coupling in accordance with claim 1, wherein the blocking body is fixable in the securing position, the intermediate position and the rest position blocking position by a blocking actuating device.

11. The trailer coupling in accordance with claim 10, wherein the blocking actuating device comprises a camming guide and a cam follower which can be moved thereby and which is coupled to the blocking body.

12. The trailer coupling in accordance with claim 11, wherein the cam follower is movable by the camming guide approximately parallel to the pivot axis.

13. The trailer coupling in accordance with claim 11, wherein the camming guide is movable transversely to the pivot axis.

14. The trailer coupling in accordance with claim 11, wherein the camming guide is movable by the blocking actuating device.

15. The trailer coupling in accordance with claim 14, wherein the blocking actuating device comprises a body carrying the camming guide and movable in rotation relative to the cam follower.

16. The trailer coupling in accordance with claim 11, wherein the camming guide has at least one camming path acting on the cam follower.

17. The trailer coupling in accordance with claim 11, wherein the camming guide has two camming paths acting on the cam follower and guiding it between them.

18. The trailer coupling in accordance with claim 17, wherein both camming paths together fix the cam follower in a position predetermining the securing position.

19. The trailer coupling in accordance with claim 17, wherein both camming paths together fix the cam follower in a position predetermining the rest position blocking position.

20. The trailer coupling in accordance with claim 17, wherein a first camming path comprises a path portion moving the cam follower from the position defining the securing position to a position defining the intermediate position.

21. The trailer coupling in accordance with claim 17, wherein the first camming path comprises a path portion moving the cam follower from the position defining the intermediate position in the direction of and into a position corresponding to the rest position blocking position.

22. The trailer coupling in accordance with claim 21, wherein the path portion acting in the direction of the position corresponding to the rest position blocking position acts resiliently on the cam follower in this direction.

23. The trailer coupling in accordance with claim 22, wherein the path portion is formed by a resiliently movable portion of the first link path.

24. The trailer coupling in accordance with claim 23, wherein, in the position corresponding to the rest position blocking position, the cam follower is fixed between the resiliently movable path portion of the first camming path in cooperation with the second camming path.

25. The trailer coupling in accordance with claim 17, wherein the second camming path has a path portion which moves the cam follower from the position corresponding to the rest position blocking position to a position corresponding to the intermediate position.

26. The trailer coupling in accordance with claim 17, wherein the second camming path has a path portion which moves the cam follower from the position corresponding to the intermediate position to a position corresponding to the securing position.

27. The trailer coupling in accordance with claim 17, wherein the first camming path is effective by a movement of the camming guide in a first rotational direction, and wherein the second camming path is effective by a movement of the camming guide in a rotational direction opposite to the first rotational direction.

28. The trailer coupling in accordance with claim 27, wherein the blocking actuating device is drivable by an actuating device for the rotation blocking device.

29. The trailer coupling in accordance with claim 28, wherein the blocking actuating device is coupled to the actuating device.

30. The trailer coupling in accordance with claim 28, wherein the camming path is arranged on a rotatable body of a planetary gearing of the actuating device for the rotation blocking device.

31. The trailer coupling in accordance with claim 30, wherein the camming path is arranged on a ring gear of a planetary gearing of the actuating device.

32. The trailer coupling in accordance with claim 1, wherein the multiple blocking device comprises a sensor unit detecting the positions of the blocking body.

33. The trailer coupling in accordance with claim 32, wherein the sensor unit detects the securing position, the rest position blocking position and the intermediate position.

34. The trailer coupling in accordance with claim 32, wherein the sensor unit is configured in such a way that it distinguishes at least the intermediate position from the securing position and the rest position blocking position, in particular distinguishes all these positions from one another.

35. The trailer coupling in accordance with claim 32, wherein the sensor unit comprises at least one push-button, in particular two push-buttons.

36. The trailer coupling in accordance with claim 32, wherein the sensor unit comprises a magnetic field sensor, in particular a magnetic field sensor detecting a course of a magnetic field in space.

37. The trailer coupling in accordance with claim 11, wherein the cam follower is coupled to the blocking body by way of a transmission element.

38. The trailer coupling in accordance with claim 37, wherein the transmission element is coupled to a sensor actuating element.

39. The trailer coupling in accordance with claim 1, wherein blocking surfaces extend between the receptacles, against which blocking surfaces the rotation blocking bodies are placeable and from which the receptacles extend, wherein the rotation blocking units and the receptacles are arranged around the pivot axis at angular spacings from one another in such a way that, in all provided relative pivot positions between pivot bearing body and guide body, including the rest position and apart from the working position, the rotation blocking body of at least one of the rotation blocking units is opposite one of the blocking surfaces, and the blocking surfaces, in particular when a force is applied to the actuating body, block a movement of the actuating body in the actuating direction and consequently also a force-loaded engagement of the rotation blocking bodies of each of the rotation blocking units into one of the receptacles.

40. The trailer coupling in accordance with claim 1, wherein the rotation blocking units are arranged at angular spacings around the pivot axis to form a rotation blocking configuration, wherein the receptacles are arranged at the same angular spacings around the pivot axis as the rotation blocking units in order to form a receptacle configuration, wherein the rotation blocking configuration and the receptacle configuration in the working position are congruent with one another, so that the rotation blocking bodies can engage in the receptacles, and wherein the angular spacings between the rotation blocking units of the rotation blocking configuration and the angular spacings between the receptacles of the receptacle configuration are selected such that the rotation blocking configuration and the receptacle configuration are congruent with one another only in the working position.

41. The trailer coupling in accordance with claim 39, wherein the angular spacings of at least one of the rotation blocking units are unequal to the rotation blocking units arranged adjacent in a direction of revolution about the pivot axis and to the rotation blocking units arranged opposite to this direction of revolution, and wherein in the working position the receptacles are arranged in such a way that the rotation blocking body of each of the rotation blocking units is configured to be brought into engagement with one of the receptacles, and wherein in all relative pivot positions between pivot bearing body and guide body which are provided for operation and which lie outside the working position, including the rest position, the rotation blocking body of at least one of the rotation blocking units is located opposite a blocking surface running between the receptacles, and the blocking surface blocks a movement of the actuating body from the release position into the rotation blocking position, in particular when force is applied to the actuating body.

42.-58. (canceled)
